(19) United States
(12) Patent Application Publication
(10) Pub. No.: US 2026/0298721 A1
(43) Pub. Date: Oct. 1, 2026

(54) Methods and Fiber Optic Sensors For Measuring Temperature of High-Enthalpy Exhaust Plumes

(71) Applicants: Stephen A. WHITMORE, Logan, UT (US); Cara BOREALIS, Logan, UT (US); Max FRANCOM, Logan, UT (US); Spencer PETERSEN, Logan, UT (US)

(72) Inventors: Stephen A. WHITMORE, Logan, UT (US); Cara BOREALIS, Logan, UT (US); Max FRANCOM, Logan, UT (US); Spencer PETERSEN, Logan, UT (US)

(73) Assignee: Utah State University, Logan, UT (US)

(21) Appl. No.: 19/039,142

(22) Filed: Jan. 28, 2025

Related U.S. Application Data
(60) Provisional application No. 63/634,429, filed on Apr. 15, 2024.

(51) Int. Cl. G01J 5/60; G01J 3/02; G01J 3/443; G01J 5/0821

(52) U.S. Cl. CPC G01J 5/601; G01J 3/0218; G01J 3/443; G01J 5/0821; G01J 5/602; G01J 2005/607; G01J 2005/608

(57) ABSTRACT

A method of measuring the temperature of a high-enthalpy exhaust plume, such as from a rocket motor, can include placing a sensing end of an optical fiber in an exhaust plume at a flame temperature. A combustion spectrum of radiation emitted by the exhaust plume can be transmitted through the optical fiber. The combustion spectrum can be received using a spectrometer connected to a receiving end of the optical fiber opposite from the sensing end. The combustion spectrum can then be fitted to a black body radiation model, such as Planck's radiation law. The flame temperature can be calculated using the black body radiation model.

### CROSS REFERENCE TO RELATED APPLICATIONS

This application claims priority to U.S. Provisional Patent Application No. 63/634,429, filed Apr. 15, 2024, which is hereby incorporated by reference.

### STATEMENT REGARDING FEDERALLY SPONSORED RESEARCH OR DEVELOPMENT

This invention was made with government support under 80NSSC22M0232 awarded by the National Aeronautics and Space Administration. The government has certain rights in the invention.

### BACKGROUND

Rocket motors are used in the human exploration of space and in missile defense systems. The design and manufacturing of these motors involves extensive simulation and testing to assure the motors will perform as intended and to minimize safety risks. Taking data from inside the rocket motors during tests is extremely difficult due to the intense temperatures inside the motor as it burns; most instrumentation cannot survive in this environment. Previous attempts to obtain these measurements, including flame temperature and combustion plume composition have been performed on combustion chambers not in a flight configuration or performed with sensors that don't last through the entire burn and/or interfere with the flow within the combustion chamber.

In situ measurements of combustion plumes of rockets and other propulsion systems are difficult due to the hostility of the environment, including the high flame temperatures and potentially oxidizing flows. These characteristics can be estimated using computational fluid dynamics (CFD) and heat transfer methods, but it would be useful in rocket design and analysis to have experimental data to work with.

One current method of collecting in situ internal rocket plume data is a Gardon gauge, which is a heat flux sensor capable of sensing very high radiative heat flux levels, but which has an invasive and complex installation process and involves frequent recalibration. The Gardon gauge is also trusted more for quasi-static measurements but is considered less reliable for transient measurements. Typically, a Gardon gauge is installed into a post in the side wall of the motor casing with a sapphire optical window to protect it from the high temperature plume. This window is easily contaminated by the internal exhaust and can be subject to stress fracture during operation. Other studies of rocket combustion have been done, but most utilize an optically accessible flame or a complicated laser setup. These setups can provide valuable insight into rocket combustion but are not feasible for use on a motor in flight configuration.

### SUMMARY

This invention relates to an instrumentation system that includes a fiberoptic cable which conducts light from the interior of a high-enthalpy exhaust plume, such as from a rocket motor or a gas turbine, to an external spectrometer, which measures this light. These optical measurements are analyzed to determine the flame temperature and may also be used to determine the relative quantities of the chemical species produced by the combustion reaction. This data can help ensure that rocket motors have sufficient insulation to contain the combustion and determine the efficiency of the combustion reaction.

In one example, a method of measuring the temperature of a high-enthalpy exhaust plume can include placing a sensing end of an optical fiber in an exhaust plume at a flame temperature. A combustion spectrum comprising radiation emitted by the exhaust plume can be transmitted through the optical fiber. This combustion spectrum can be received by a spectrometer connected to a receiving end of the optical fiber opposite from the sensing end. The combustion spectrum can then be fitted to a black body radiation model. The flame temperature can be calculated using the black body radiation model.

An example fiber optic temperature sensor for high-enthalpy exhaust plumes can include an optical fiber having a sensing end to be placed in an exhaust plume at a flame temperature, and a receiving end opposite from the sensing end. A spectrometer can be connected to the receiving end of the optical fiber to receive a combustion spectrum comprising radiation emitted by the exhaust plume and transmitted through the optical fiber. A controller can be in communication with the spectrometer and configured to fit the combustion spectrum to a black body radiation model and calculate the flame temperature using the black body radiation model.

An example rocket exhaust plume temperature measuring system can include a rocket motor configured to burn a fuel to form an exhaust plume at a flame temperature, an optical fiber having a sensing end placed in the exhaust plume and a receiving end opposite from the sensing end, and a spectrometer connected to the receiving end of the optical fiber to receive a combustion spectrum comprising radiation emitted by the exhaust plume and transmitted through the optical fiber. A controller can be in communication with the spectrometer and configured to fit the combustion spectrum to a black body radiation model and calculate the flame temperature using the black body radiation model.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a flowchart illustrating an example method of measuring temperature of a high-enthalpy exhaust plume in accordance with an example of the present technology.

FIG. 2 is a schematic view of an example fiber optic sensor in accordance with an example of the present technology.

FIG. 3 is a schematic view of another example fiber optic sensor in accordance with an example of the present technology.

FIG. 4 is a schematic view of an example rocket exhaust plume temperature measuring system in accordance with an example of the present technology.

FIG. 5A is a perspective exploded view of an example rocket exhaust plume temperature measuring system in accordance with an example of the present technology.

FIG. 5B is a perspective assembled view of the example of FIG. 5A.

FIG. 6 is a schematic view of another example rocket exhaust plume temperature measuring system in accordance with an example of the present technology.

FIG. 7 is a schematic view of an example gas turbine exhaust plume temperature measuring system in accordance with an example of the present technology.

FIG. 8 is a schematic illustration of a 75 mm hybrid motor with fiberoptic adapter which can be used in accordance with another example.

FIG. 9 is a graph of Ensemble mean FTIR spectra for ABS samples in accordance with an example of the present disclosure.

FIG. 10 is a graph of least squares curve fit model compared to ensemble spectrum in accordance with an example of the present disclosure.

FIGS. 11A and 11B a graphs of GOX/ABS plume species concentrations for near optimal O/F in accordance with an example of the present disclosure.

FIG. 12 is a test setup piping and instrumentation diagram in accordance with an example of the present disclosure.

FIG. 13 is a graph of Predicted spectral signature of calibration tungsten light in accordance with an example of the present disclosure.

FIG. 14 is a graph of Filtered spectra through blue fiberoptic with LR-1 in accordance with an example of the present disclosure.

FIG. 15 is a graph of Wavelength calibration for blue fiberoptic cable in accordance with an example of the present disclosure.

FIG. 16 is a graph of Transfer function for blue fiberoptic with LR-1 spectrometer in accordance with an example of the present disclosure.

FIG. 17 is a graph of Signal to noise ratio for LR-1 with blue fiberoptic in accordance with an example of the present disclosure.

FIG. 18 is a graph of Filtered spectra through clear fiberoptic with LR-1 in accordance with an example of the present disclosure.

FIG. 19 is a graph of Wavelength calibration for clear fiberoptic cable in accordance with an example of the present disclosure.

FIG. 20 is a graph of Transfer function for clear fiberoptic with LR-1 spectrometer in accordance with an example of the present disclosure.

FIG. 21 is a graph of Signal to noise ratio of LR-1 with clear fiberoptic in accordance with an example of the present disclosure.

FIG. 22 is a graph of Wavelength calibration with each fiberoptic for LR-1 spectrometer in accordance with an example of the present disclosure.

FIG. 23 is a graph of Transfer functions for LR-1 with each fiberoptic in accordance with an example of the present disclosure.

FIG. 24 is a graph of Filtered spectra compared to reference spectra, Qneo with IR fiberoptic in accordance with an example of the present disclosure.

FIG. 25 is a graph of Transfer function for Qneo spectrometer with IR fiberoptic in accordance with an example of the present disclosure.

FIG. 26 is a graph of Signal to noise ratio of Qneo with IR fiberoptic in accordance with an example of the present disclosure.

FIG. 27 is a graph of Combined fuel regression rates for three 100% throttle burns in accordance with an example of the present disclosure.

FIG. 28 is a graph of Raw data from LR-1 spectrometer (September 15 Burn 1) in accordance with an example of the present disclosure.

FIG. 29 is a graph of LR-1 data after transfer function with wiener filter (September 15 Burn 1) in accordance with an example of the present disclosure.

FIG. 30 is a graph of Raw data from Qneo spectrometer (September 15 Burn 1) in accordance with an example of the present disclosure.

FIG. 31 is a graph of Qneo data after transfer function with wiener filter (September 15 Burn 1) in accordance with an example of the present disclosure.

FIG. 32 is a graph of Spliced data sets with Qneo×1.25 (September 15 Burn 1) in accordance with an example of the present disclosure.

FIG. 33 is a graph of Full spliced data curve (September 15 Burn 1) in accordance with an example of the present disclosure.

FIG. 34 is a graph of LR-1 data using exact deconvolution (September 15 Burn 1) in accordance with an example of the present disclosure.

FIG. 35 is a graph of Qneo data using exact deconvolution (September 15 Burn 1) in accordance with an example of the present disclosure.

FIG. 36 is a graph of Spliced data, exact deconvolution (September 15 Burn 1) in accordance with an example of the present disclosure.

FIG. 37 is a graph of Curve fit with exact deconvolution (September 15, Burn 1) in accordance with an example of the present disclosure.

FIG. 38 is a graph of Spliced data curve fit to Planck's law with Wiener filter (September 15 Burn 1) in accordance with an example of the present disclosure.

FIG. 39 is a graph of Curve fit with just visible light data (September 15 Burn 1) in accordance with an example of the present disclosure.

FIG. 40 is a graph of Both spectrometer data (September 15, Burn 2) in accordance with an example of the present disclosure.

FIG. 41 is a graph of Spliced data curve fit to Planck's law (September 15 Burn 2) in accordance with an example of the present disclosure.

FIG. 42 is a graph of Both spectrometer data, no smoothing (August 9, Burn 1) in accordance with an example of the present disclosure.

FIG. 43 is a graph of Spliced data curve fit to Planck's law (August 9, Burn 1) in accordance with an example of the present disclosure.

FIG. 44 is a graph of Both spectrometer data, no smoothing (August 9, Burn 2) in accordance with an example of the present disclosure.

FIG. 45 is a graph of Spliced data curve fit to Planck's law (August 9, Burn 2) in accordance with an example of the present disclosure.

FIG. 46 is a graph of Data from nozzle burn, visible wavelengths only (June 22, Burn 2) in accordance with an example of the present disclosure.

FIG. 47 is a graph of Nozzle curve fit data (June 22, Burn 2) in accordance with an example of the present disclosure.

FIG. 48 is a graph of Flame temperature vs O/F ratio, collected data set in accordance with an example of the present disclosure.

FIG. 49 is a graph of Predicted plume species for ABS/GOX motor in accordance with an example of the present disclosure.

FIG. 50 is a graph of Example emission lines from nozzle data, visible light in accordance with an example of the present disclosure.

FIG. 51 is a graph of Example absorption dip from chamber data, IR light in accordance with an example of the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used. The singular forms “a,” “an,” and “the” include plural referents unless the context clearly dictates otherwise. Thus, for example, reference to “a sensor” includes reference to one or more of such devices and reference to “injecting” refers to one or more of such actions.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc.

The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Fiber Optic Temperature Sensors for High-enthalpy Exhaust Plumes

The present technology includes fiber optic sensors and methods for measuring the temperature of high-enthalpy exhaust plumes. These sensors and methods can be used to measure the flame temperature within an exhaust plume from a variety of combustion sources. The exhaust plumes can be produced by sources such as rocket motors, gas turbines, and others. Many of the examples described herein apply to rocket motors in particular. The flame temperature in rocket motors can be difficult to measure directly. Wetted sensors, such as thermocouples and pressure transducers, degrade rapidly in the reactive, particle-laden, high-temperature, and often highly oxidizing exhaust plume of a rocket motor. As mentioned above, Gardon sensors have been used, but these sensors experience issues such as stress fractures of the optical window and contamination from exhaust products. Water cooling is often used with Gardon sensors, making these sensors too large and heavy to use in flight.

The technology described herein provides optical sensing systems that are minimally intrusive, small, light in weight, and which can accurately measure flame temperatures of rocket motors to within a few degrees. The sensors described herein can include an optical fiber, such as a glass or plastic fiber optic cable, which can be inserted directly into the exhaust plume of the rocket motor. For example, the optical fiber can be inserted through the solid fuel grain of the rocket motor or through a wall of the rocket nozzle. The end of the optical fiber that is in the exhaust plume can be referred to as the “sensing end,” and this end can take in electromagnetic radiation emitted by the hot materials in the exhaust plume. The exhaust can emit a particular spectrum of electromagnetic radiation that is characteristic of the temperature of the exhaust plume. This spectrum of emitted radiation can be referred to as the “combustion spectrum” of the exhaust plume. The combustion spectrum can be taken in by the sensing end of the optical fiber and transmitted through the optical fiber to the opposite end of the optical fiber, which is referred to as the “receiving end.” This end can be connected to a spectrometer, which receives the transmitted radiation and measures the intensity of radiation at the various wavelengths across the spectrum. In some cases, the spectrometer can be capable of measuring only a portion of the wavelengths present in the combustion spectrum. Therefore, some examples can include two or more spectrometers that measure different wavelength ranges in order to provide a more complete picture of the combustion spectrum.

The combustion spectrum that is received by the spectrometer or spectrometers can be processed by fitting the spectrum data to a blackbody radiation model. For example, Planck's radiation law can be used as a model of blackbody radiation. In some examples, the combustion spectrum can be fitted to Planck's radiation law, and then the fitted equation can be used to calculate the temperature of the exhaust plume. In further examples, Planck's radiation law can be used to calculate a peak wavelength in the combustion spectrum, and the peak wavelength can be used in Wien's displacement law to calculate the temperature of the exhaust plume. Other processing steps can also be performed on the combustion spectrum data received by the spectrometer. In some cases, the data measured by the spectrometer may not match the actual radiation spectrum emitted by the exhaust plume because of limitations of the optical fiber, the spectrometer, and/or the connections between the optical fiber and the spectrometer. A transfer function can be used to correct the combustion spectrum data received by the spectrometer. Additionally, the spectrum data can be processed using a noise filter to reduce noise in the spectrum data. In some cases, the combustion spectrum can include peaks that are characteristic of certain chemical species present in the exhaust plume. These peaks can be used to determine the composition of the exhaust plume. Thus, the sensors described herein can measure the temperature of the exhaust plume and the chemical composition of the exhaust plume in some examples.

The sensors and methods described herein were tested experimentally using hybrid rocket motors having an ABS plastic fuel grain and gaseous oxygen as an oxidizer. The temperatures calculated based on spectrometer data were compared to temperatures calculated using simulations. The temperatures generally agreed within a few degrees. Additionally, local maxima in the optical spectra were shown to correspond to emission frequencies of atomic and molecular oxygen, water vapor, and molecular nitrogen-all species known to exist in the hybrid combustion plume. The experiments also showed that the optical fiber can survive temperature greater than 3000° C. for durations of up to 25 seconds.

In many examples of the present technology, the fiber optic sensors can be utilized in exhaust plumes of rocket motors. There are three common types of chemical rockets: solids, liquids, and hybrids. Solid rockets use a solid propellent where the fuel and oxidizer are mixed with a binder and cast into a specific shape based on the desired burn characteristics. Solid motors are exceptionally difficult to stop once they have been lit and cannot be throttled or adjusted once burning. Liquid motors use a liquid fuel and a liquid oxidizer, stored separately, and mixed for combustion when the rocket is lit. These can be throttled, stopped, and restarted, but are much more complicated than solid motors. Hybrid motors use solid fuel and liquid or gaseous oxidizer. They are generally safer than either solids or liquids due to a lower chance of accidental ignition.

These types of rocket motors burn in different ways. Solid and hybrid motors have a solid fuel grain that usually burns from the inside out. End burners exist but are generally less useful due to the change in the rocket's center of mass over the burn time and limitations in tailorable pressure trace output. Liquid rockets do not have a solid component and contain a combustion chamber where the oxidizer and fuel are mixed and ignited before exiting through the nozzle. Hybrid rockets have a solid fuel grain that burns from the inside out as the oxidizer is sprayed down the center.

In some specific examples, hybrid rocket motors can include a solid fuel grain made of acrylonitrile butadiene styrene (ABS) plastic and gaseous oxygen (GOX) as an oxidizer. Other oxidizers that can be used include nitrox (nitrous oxide with extra oxygen mixed in), and hydrogen peroxide. The test rocket motors used in the experiments described herein include a 3D printed ABS igniter cap that utilizes electric ignition. These motors can be reliably ignited and throttled to various levels of thrust.

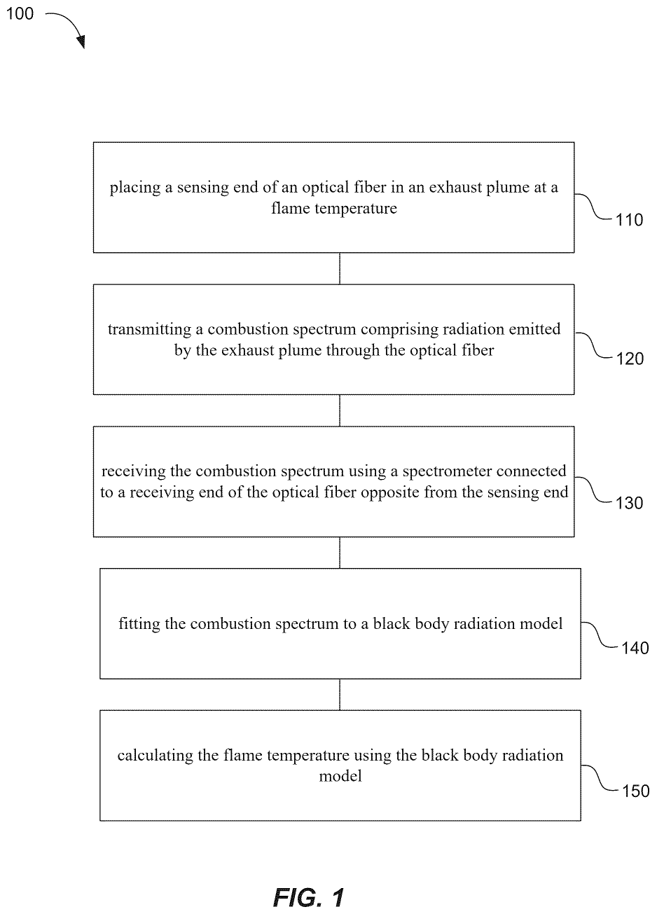

With this description in mind, FIG. 1 is a flowchart illustrating and example method 100 of measuring temperature of a high-enthalpy exhaust plume. This method includes: placing a sensing end of an optical fiber in an exhaust plume at a flame temperature 110; transmitting a combustion spectrum comprising radiation emitted by the exhaust plume through the optical fiber 120; receiving the combustion spectrum using a spectrometer connected to a receiving end of the optical fiber opposite from the sensing end 130; fitting the combustion spectrum to a black body radiation model 140; and calculating the flame temperature using the black body radiation model 150.

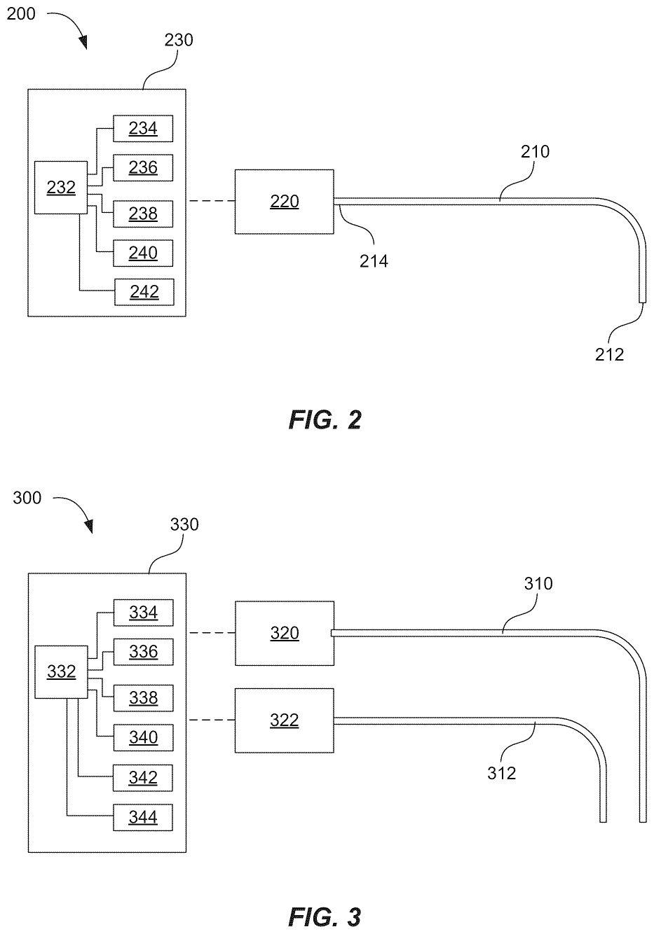

FIG. 2 shows an example fiber optic temperature sensor 200 for high-enthalpy exhaust plumes. This sensor includes an optical fiber 210 having a sensing end 212 and a receiving end 214 opposite from the sensing end. The sensing end can be placed in an exhaust plume at a flame temperature. A spectrometer 220 is connected to the receiving end of the optical fiber. The receiving end can receive light (i.e., radiation including visible light and/or non-visible light such as infrared) that is transmitted through the optical fiber. When the sensing end of the optical fiber is placed in an exhaust plume, the optical fiber can transmit light emitted by the exhaust plume. This light is referred to as a “combustion spectrum.” The spectrometer receives and measures this combustion spectrum. A controller 230 is in communication with the spectrometer and configured to fit the combustion spectrum to a black body radiation model and calculate the flame temperature using the black body radiation model. The connection between the controller and the spectrometer is illustrated as a dashed line in this figure. In various examples, the controller can be connected to the spectrometer by a wired or wireless connection. The controller can include a processor 232 and optionally modules that are configured to calculate the flame temperature. The controller can be configured to calculate the flame temperature in a variety of ways. In this particular example, the controller includes a transfer function module 234 configured to apply a transfer function to the received combustion spectrum, a filter module 236 configured to apply a filter to the received combustion spectrum, a Planck's radiation law module 238 configured to fit the combustion spectrum to Planck's radiation law, a Wien's displacement law module 240 configured to calculate the flame temperature using Wien's displacement law, and a chemical species module 242 configured to calculate relative amounts of chemical species in the exhaust plume. These various functions are described in more detail below.

In some cases, the spectrum that is measured by the spectrometer may not match with complete fidelity the spectrum of radiation that is actually emitted by the burning fuel in the exhaust plume. This can be because the optical fiber may not be capable of transmitting all the wavelengths at the same intensity as they are present in the radiation emitted by the exhaust plume. Furthermore, the spectrometer may not be capable of measuring all the wavelengths transmitted by the optical fiber. Thus, the spectrum data measured by the spectrometer can be somewhat different from the spectrum actually emitted by the exhaust plume. Despite these differences, the term “combustion spectrum” is used herein to refer to the actual radiation emitted from the exhaust plume, and to the radiation transmitted by the optical fiber, and to the radiation measured by the spectrometer. In some examples, transfer functions and noise filters can be used to correct the spectrum data measured by the spectrometer to align it more closely with the actual radiation emitted by the exhaust plume, as described in more detail below.

Some spectrometers are capable of measuring radiation within a certain range of wavelengths. The range of wavelengths measured by a single spectrometer can be narrower than the combustion spectrum that is desired to be measured by the sensors described herein. Therefore, in some examples it can be useful to utilize two or more spectrometers that are configured to measure different wavelength ranges. The data measured by both or all of the spectrometers can be combined when calculating the flame temperature.

FIG. 3 shows an example fiber optic sensor 300 that includes a first optical fiber 310 connected to a first spectrometer 320 and a second optical fiber 312 connected to a second spectrometer 322. A sensing end of both the first and second optical fibers can be placed into an exhaust plume. In this way, both fibers can receive the combustion spectrum of radiation generated by the exhaust plume. Both optical fibers can transmit the combustion spectrum back to their respective spectrometers. The spectrometers can be configured to measure different ranges of wavelengths. Therefore, the data measured by each spectrometer can be different, covering a different portion of the combustion spectrum. The first and second spectrometer are each connected to a controller 330 by a wired or wireless connection. As in the previous example, the controller includes a processor 332 and several modules including a transfer function module 334, a filter module 336, a Planck's radiation law module 338, a Wien's displacement law module 340, and a chemical species module 342. In this example, the controller also includes a spectrometer data scaling module 344, which can be configured to scale the data from one or both spectrometers to correct for scaling differences between the spectrometers.

In further examples, more than two spectrometers can be used if desired to measure spectrum data covering more portions of the combustions spectrum. Any number of additional spectrometers can be used in a similar way to the example above. Each spectrometer can be connected to a receiving end of an optical fiber. The sensing end of the optical fiber can be placed in the exhaust plume. The spectrometers can be used to measure different ranges of wavelengths, and the data from all the spectrometers can be scaled if needed and combined to use for fitting the black body radiation model and thus calculating the flame temperature of the exhaust plume.

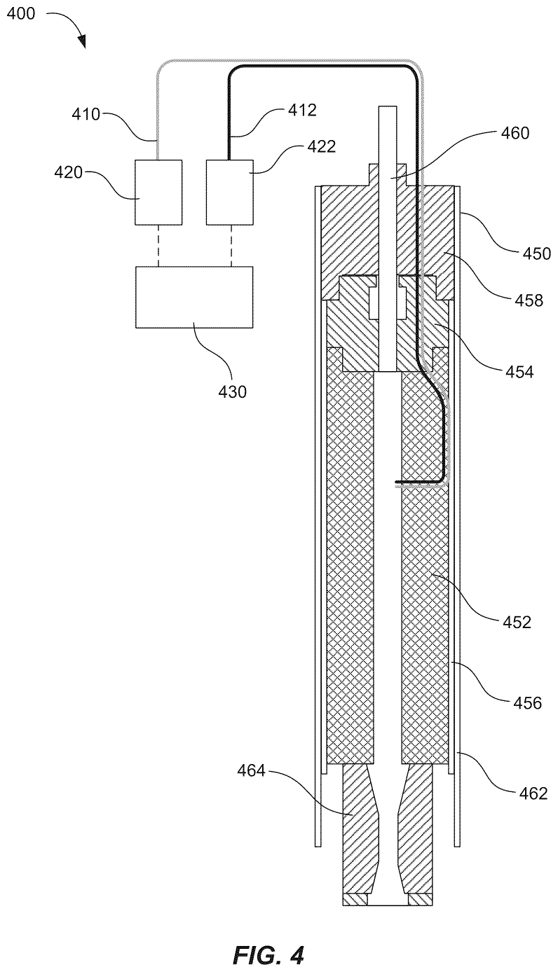

The present disclosure also extends to rocket exhaust plume temperature measuring systems, that include a rocket motor and a sensor for measuring the flame temperature of the exhaust plume. One example is shown in FIG. 4. This system 400 includes a rocket motor 450 that includes a fuel grain 452 that can burn to form an exhaust plume at a flame temperature. In this example, the fuel grain can be made of plastic such as ABS. An ignition cap 454 is placed on the top of the fuel grain. The ignition cap can be part of an electric arc-based ignition system that uses an electric arc to ignite the fuel. In some examples, the ignition cap can be made from the same plastic material as the fuel grain. A liner 456 is around the fuel grain and the ignition cap. An injection cap 458 is placed over the ignition cap. The injection cap includes an oxidizer inlet 460. An oxidizer, such as gaseous oxygen, can flow through this inlet to the fuel grain to provide the oxidizer for combustion. A motor case 462 surrounds all these components. A rocket nozzle 464 is positioned at the bottom of the rocket motor. The exhaust plume generated by burning the fuel grain is directed through the rocket nozzle to increase the thrust of the rocket motor. This system includes a first optical fiber 410 and a second optical fiber 412. Both of these optical fibers are routed into the interior of the fuel grain. Specifically, the fibers pass through the injection cap, through the ignition cap, and then through the side of the fuel grain so that the sensing ends of the optical fibers are located in the interior of the fuel grain. Since the fuel grain burns at the interior surface, the sensing ends of the optical fibers will be directly in the plume of burning fuel. The first optical fiber is connected to a first spectrometer 420, and the second electrical fiber is connected to a second spectrometer 422. Both spectrometers are connected to a controller 430. The controller can be configured to fit the combustion spectrum as measured by the spectrometers to a black body radiation model and calculate the flame temperature using the black body radiation model.

As shown in the example above, the optical fiber (or fibers) can be routed through the fuel grain wall and into the interior volume of the fuel grain. The fuel grain can be designed and formed with a channel for the optical fiber, or the fuel grain can be formed as a solid cylindrical tube and a channel can be drilled in the fuel grain wall. The optical fiber can then be inserted through the channel. In some examples, an adhesive can be used to hold the optical fiber in place and to fill gaps in the channel. This can prevent exhaust from leaking out of the fuel grain through the channel when the fuel grain is burning.

In various examples, the sensing end of the optical fiber can protrude into the interior volume of the fuel grain, or the sensing end can be flush with an interior wall of the fuel grain, or the sensing end can be recessed in the channel. In certain examples, the optical fiber can protrude about to a central axis of the fuel grain. In alternative examples, the optical fiber can protrude from the interior wall of the fuel grain to about 10% to 90% of the distance to the central axis of the fuel grain. In further examples, the optical fiber can protrude from the interior wall by about 1 mm to about 50 mm. When the fuel grain burns, in some cases the optical fiber can melt or burn along with the fuel. The optical fiber can burn or melt away at nearly the same rate as the fuel in some examples. In certain examples, a portion of the optical fiber can always protrude from the side wall of the fuel grain throughout the burn even when the optical fiber burns/melts away while the fuel is burning.

In more detail regarding the ignition cap, in some examples the ignition cap can be designed and formed with a channel for the optical fiber to pass through. In other examples, the ignition cap can be formed without a channel, and a channel can be drilled in the ignition cap for the optical fiber to pass through. The ignition cap can be made by 3D printing, injection molding, machining, or another suitable method. In certain examples, the ignition cap can be made from the same material as the fuel grain, such as ABS plastic. Electrodes can be placed in the ignition cap and configured to create an electric arc that can ignite combustion of the material making up the ignition cap. An oxidizer can be supplied to the ignition cap to support this combustion. This combustion can then ignite the fuel grain.

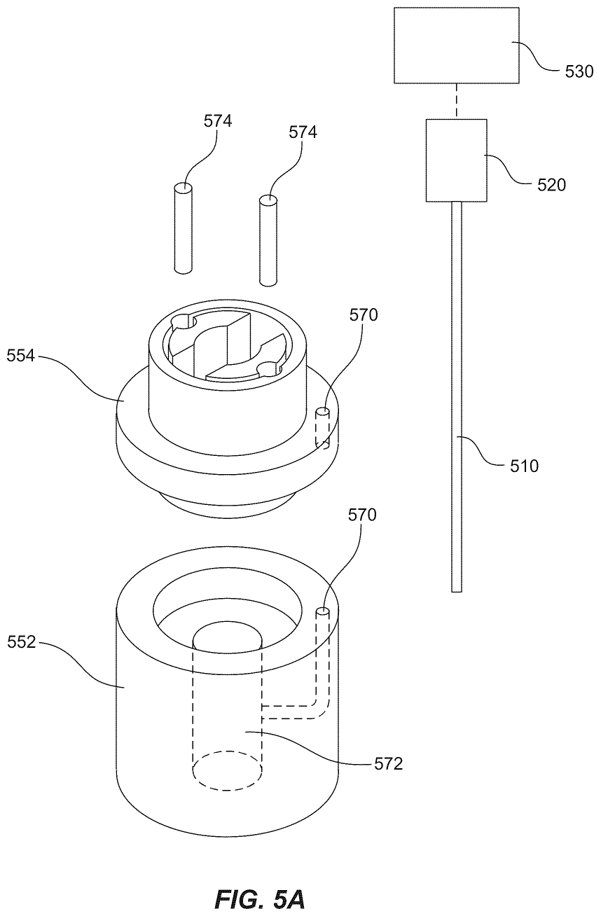

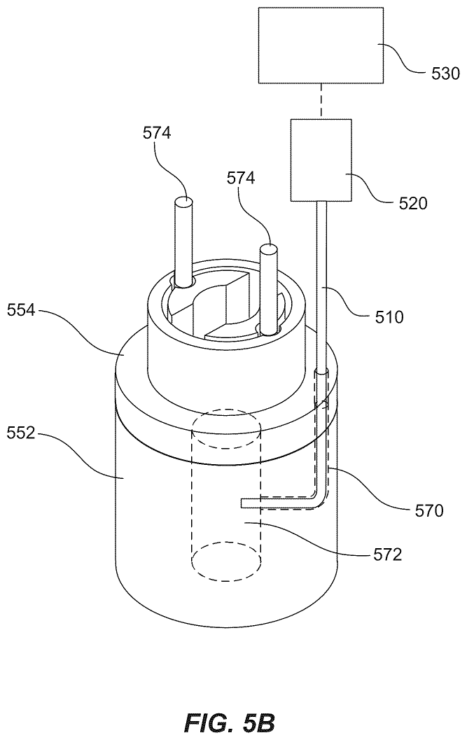

One example ignition cap design is shown in FIGS. 5A and 5B. FIG. 5A shows an exploded view of the ignition cap 554 with a fuel grain 552. The fuel grain is shaped so that the ignition cap fits on the top of the fuel grain. The ignition cap and fuel grain both include a channel 570 formed to allow an optical fiber 510 to be inserted through the ignition cap and the fuel grain and protrude into the interior volume 572 of the fuel grain. The optical fiber is connected to a spectrometer 520, which is connected to a controller 530. Two electrodes 574 can be inserted into the ignition cap. These can be connected to an electric power supply to form an electric arc that ignites the solid fuel material from which the ignition cap is made. This combustion can then ignite the fuel grain below. FIG. 5B shows these components after being assembled.

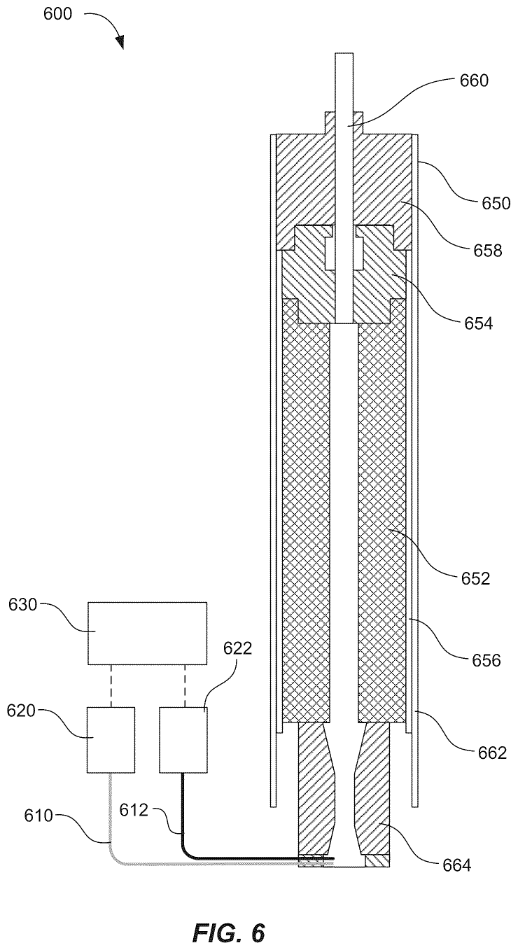

The sensing end of the optical fiber can also be placed in the nozzle of the rocket motor. FIG. 6 shows another example system 600 with this arrangement. As in the previous example, the system includes a rocket motor rocket motor 650 that includes a fuel grain 652, an ignition cap 654 placed on the top of the fuel grain, a liner 656 around the fuel grain and the ignition cap, and an injection cap 658 placed over the ignition cap. The injection cap includes an oxidizer inlet 660. In this example, a motor case 662 surrounds all these components. A rocket nozzle 664 is positioned at the bottom of the rocket motor. A first optical fiber 610 and a second optical fiber 612 are inserted through the side wall of the nozzle so that the optical fibers protrude from the interior wall of the rocket nozzle into the interior volume of the rocket nozzle. In this position, the sensing ends of the optical fibers are directly in the path of the exhaust plume. The optical fibers are connected to a first spectrometer 620 and a second spectrometer 622. Both spectrometers are connected to a controller 630. The controller can be configured to calculate the flame temperature in the inside of the nozzle using the spectrum data measured by the spectrometers.

The examples shown above utilize a hybrid rocket motor, which includes a solid fuel grain and a separate oxidizer. The oxidizer can be a gas or liquid depending on the type of oxidizer used. However, other rocket motors can also be used such as solid rocket motors and liquid rocket motors. In solid rocket motors, the fuel and oxidizer can be present together in a solid fuel grain. In such examples, the optical fiber can be inserted through the side wall of the fuel grain or placed in the nozzle as in the examples above. A liquid right motor does not include a solid fuel grain, but includes liquid fuel and oxidizer that are mixed at the time of combustion. In these rocket motors, the optical fiber can be placed in the nozzle to measure the flame temperature in the nozzle.

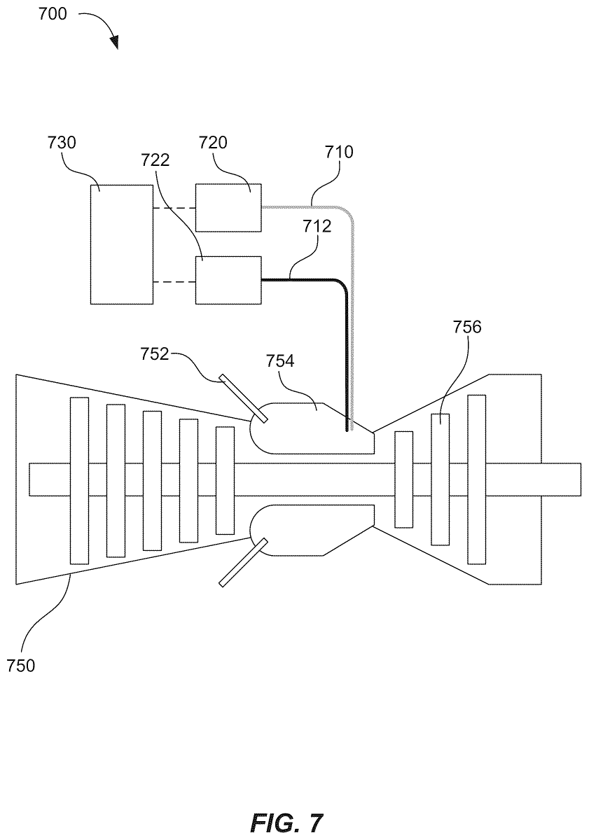

In further examples, the sensors described herein can be used in high enthalpy exhaust plumes produced by other combustion sources besides rocket motors. In certain examples, the sensors can be used to measure the flame temperature of a gas turbine. FIG. 7 shows an example system 700 that includes a gas turbine 750. A fuel injector 752 provides fuel to a combustion nozzle 754, where the fuel is burned. The exhaust is directed from the nozzle into rotors 756 to provide power to the gas turbine. In this example, a first optical fiber 710 and a second optical fiber 712 are inserted into the combustion nozzle. The sensing ends of the optical fibers can receive a combustion spectrum of radiation emitted by the exhaust plume in the combustion nozzle. The optical fibers are connected to a first spectrometer 720 and a second spectrometer 722, which are connected to a controller 730. The controller can calculate the flame temperature in the combustion nozzle using the spectrum data measured by the spectrometers.

The sensors described herein can be useful for use in high temperature environments. In some examples, the flame temperature at the sensing end of the optical fiber can be from 1500° C. to 3500° C., or from 2000° C. to 3000° C., or from 2500° C. to 3500° C., or from 3000° C. to 3500° C. The exhaust plume can also contain oxidizer that has not yet reacted with fuel. Vaporized fuel, liquified fuel, and solid particles of fuel can also be present in the exhaust plume. All these factors can contribute to the degradation of the sensing end of the optical fiber. However, it has been shown experimentally that the optical fiber can continue to transmit useful combustion spectrum radiation even when the sensing end burns, melts, or is otherwise degraded while the fuel burns.

Since the optical fiber is inexpensive, it can be treated as a disposable component. In some examples, the optical fiber can burn or melt away with the fuel grain. If a rocket motor is reused, the fuel grain can be replaced with a new fuel grain and the optical fiber can be replaced with a new optical fiber. The new optical fiber can be connected to the spectrometer. The same spectrometer and controller can be reused multiple times. In examples where the optical fiber is inserted into the nozzle of the rocket motor, the optical fiber may degrade less than when the optical fiber is embedded in the fuel grain. In some examples, the optical fiber in the nozzle can be degraded after firing a rocket motor, but instead of replacing the entire optical fiber before reuse, the end of the optical fiber can be trimmed and the optical fiber can be adjusted so that a desired length of optical fiber protrudes into the nozzle. In certain examples, one optical fiber can be reused several times in the nozzle of a rocket motor before it is adjusted or trimmed.

The optical fibers used in the sensors described herein can be glass optical fibers, polymeric optical fibers, or any other suitable optical fibers. In certain examples, the optical fibers can be multi-mode optical fibers. The core diameter of the optical fiber can be from 300 μm to 1,000 μm, or from 400 μm to 600 μm in certain examples. The core can be sheathed by sheathing, which can have any suitable thickness. In some examples, the sheathing thickness can be from about 100 μm to about 2 mm. The optical fiber can be capable of transmitting radiation at wavelengths from 300 nm to 2200 nm or a portion of that range. The numerical aperture (NA) of the optical fiber is a measure of the acceptance angle of the fiber. The NA is defined as the sine of the largest angle of incident rays totally captured by the fiber core. In some examples, the NA of the optical fiber can be from about 0.3 to about 0.4.

The combustion spectrum that is emitted by exhaust plumes can often have a peak wavelength within the range of 300 nm to 2200 nm. The region around the peak wavelength can be particularly useful for fitting a black body radiation model to the combustion spectrum. Therefore, the combination of the optical fiber and the spectrometer can be configured to measure radiation within at least a portion of the range from 300 nm to 2200 nm. In further examples, the optical fiber and spectrometer can be capable of measuring wavelengths in at least a portion of the range from 500 nm to 2000 nm, or from 800 to 1500 nm, or from 900 nm to 1200 nm. As mentioned above, in some examples two or more spectrometers can be used to cover a wider range of wavelengths. Two spectrometers can be used which are configured to measure different ranges of wavelengths. In one example, the first spectrometer can be configured to measure in the range of visible to near infrared, and the second spectrometer can be configured to measure in the range of near infrared to mid-infrared. In another example, the first spectrometer can measure at least a portion of the range from 300 nm to 950 nm, and the second spectrometer can measure at least a portion of the range from 950 nm to 2200 nm. In some examples, the two spectrometers can be configured to measure overlapping wavelengths. In other examples, the two spectrometers can measure ranges that do not overlap, where there is a gap between the ranges measured by the two spectrometers. These relationships between the ranges of wavelengths measured by spectrometers can also apply when more than two spectrometers are used.

After combustion spectrum data has been measured by the spectrometer or multiple spectrometers, the measured combustion spectrum can be fit to a black body radiation model. The black body radiation model used in the examples herein is Plank's radiation law. This law is shown as equation 1:

$${B}_{A} ( λ , T ) = 2 \cdot A \cdot \frac{h \cdot {c}^{2}}{{λ}^{5}} \cdot \frac{1}{{e}^{( \frac{h \cdot c}{λ \cdot {k}_{B} \cdot T} )} - 1} \qquad ( 1 )$$

In equation 1, h is Planck's constant, c is the speed of light in a vacuum, kB is Boltzmann's constant, λ is the emission wavelength, T is the absolute gas temperature, and A is the amplitude scaling factor. An approximation of this law, called Wien's displacement law, can be used to calculate flame temperature base on the wavelength of maximum emittance (2max) in the combustion spectrum. Wien's law is shown as equation 2:

$${T}_{flame} = \frac{2.8 \; 978 \times {10}^{6} nm \cdot K}{{λ}_{max}} \qquad ( 2 )$$

The spectrum data collected using a spectrometer can also be processed before being fit to Planck's radiation law. First, the response range of the spectrometer can be used to scale the output wavelengths and amplitudes of the raw optical sensor data. Then a transfer function can be used to account for the spectrometer sensitivity at different wavelengths.

The data can then be filtered using the optimal deconvolution algorithm as originally developed by Norbert Wiener in the frequency domain (the Wiener filter). The original method is modified to replace frequency with wavelength as the independent variable. The deconvolution algorithm amplifies attenuated spectrum signals, while selectively rejecting sensor noise. The model inversion equation, as developed by Wiener, is presented by equation 3.

$$\hat{S} ( λ ) = \{ \frac{Υ ( λ ) {( \frac{S}{{N}_{λ}} )}^{2}}{{Υ ( λ )}^{2} {( \frac{S}{{N}_{λ}} )}^{2} + 1} \} S ( λ ) \qquad ( 3 )$$

where Ŝ(λ) is the adjusted spectrum wavelength for each input wavelength λ; S(λ) is the raw input radiance at each wavelength λ; Y(λ) is the spectrometer transfer function coefficient at λ; and S/N_{λ} is the signal-to-noise ratio at a given λ. The filter noise scaling parameter S/M_{λ}, technically represents the mean-square signal-to-noise ratio of the unknown true input signal but can be approximated by the square of the signal-to-noise ratio (S/N) of the measured output signal. The Wiener solution weights the spectrum coefficients to compensate for the S/N of the system as a function of the input signal wavelength. There are also adaptive Wiener filtering algorithms that estimate S/N as part of the filtering process, which can be used in some examples. In the examples herein, S/N values were chosen beforehand based on the observed noise threshold of the raw spectra signals. The S/N ratio was estimated for each combination of spectrometer and fiberoptic cables.

The raw optical data can be smoothed using a finite impulse response filter. The difference between the filtered signal and the raw signal can be used to approximate the amount of random noise in the signal, as shown in equation 4.

$$S \to Filtered , Smoothed T . F . \tilde{S} \to Unfiltered T . F . N \to \vert \tilde{S} - S \vert \qquad ( 4 )$$

Using a numerical coefficient & to avoid dividing by zero, the equation is the shown in equation 5.

$${S}_{N}^{′} = \frac{S}{N + ε} = \frac{1}{( \frac{N}{S} + \frac{ε}{S} )} \qquad ( 5 )$$

The solved equation for signal to noise ratio at each wavelength is shown in equation 6.

$$\frac{S}{{N}_{λ}} = \frac{S}{( \frac{S}{{S}_{N}^{′}} - ε )} \qquad ( 6 )$$

Then, the black-body spectrum as predicted by Planck's radiation law (Equation 1) is curve-fit to the data with the response amplitude A, and the temperature T, as independent variables. Planck's radiation law can be rewritten with A and T as the independent variables as in equation

$$F ( A , T ) ≡ {B}_{A} ( λ , T ) = 2 \cdot A \cdot \frac{h \cdot {c}^{2}}{{λ}^{5}} \cdot \frac{1}{{e}^{{( \frac{hc \cdot }{λ {k}_{B} T} )}_{- 1}}} \qquad ( 7 )$$

An iterative, non-linear squares regression algorithm can be applied. Wien's law (Equation 2) can be used to calculate the flame temperature using the peak wavelength found using the fitted curve of Planck's radiation law.

When two or more spectrometers are used, the data from each spectrometer can be spliced together to provide data for a more complete combustion spectrum. The data can be filtered and deconvolved as described above before splicing the data together. Different spectrometers can have different output scales. Therefore, a scaling factor can be used to convert the data to the same scale. For example, if the data from a first spectrometer “SP1” is to be used at its original scale, and the data from a second spectrometer “SP2” is to be modified by multiplying it by a scaling factor K, then equation 8 can be used to form the spliced spectrum data.

$$\hat{S} ( λ ) = {[ \{ \frac{Υ ( λ ) {( S / {N}_{λ} )}^{2}}{{Υ ( λ )}^{2} {( S / {N}_{λ} )}^{2} + 1} \} S ( λ ) ]}_{S P 1} + K \cdot {[ \{ \frac{Υ ( λ ) {( S / {N}_{λ} )}^{2}}{{Υ ( λ )}^{2} {( S / {N}_{λ} )}^{2} + 1} \} S ( λ ) ]}_{S P 2} \qquad ( 8 )$$

This equation can be fit to the Planck's radiation law equation above. Since K is not known, K can be iteratively varies and the value of K that results in the minimum variance fit for Planck's law can be selected.

The measured spectrum data can also be used to measure relative amounts of various chemical species present in the exhaust plume, to provide information about the composition of the exhaust plume. This can be accomplished by finding emittance peaks in the spectrum that match emission wavelengths of particular chemical species. A detailed example of analyzing combustion spectrum data in this way is provided in the examples below.

The processing of the spectrum data can be performed by a controller as described in the examples above. The controller can be connected to the spectrometer or spectrometers by a wired or wireless connection that allows the controller to receive the spectrum data measured by the spectrometers. The controller can include a processor and programming to perform the processing calculations described above. In some examples, the controller can be a personal computer, laptop, tablet, mobile phone, or other such computing device. In other examples, the controller can be a microcontroller or other dedicated controller used specifically to process the spectrum data. The controller can include a memory device with programmed instructions to perform the calculations described above, including filtering spectrum data, applying transfer functions to spectrum data, splicing data from multiple spectrometers, fitting spectrum data to a black body radiation model, calculating the flame temperature, identifying chemical species in the exhaust plume based on emission peaks, or any combination of these operations. In further examples, controller can include an electronic display or can be connected to an electronic display, which can display results of these calculations. In particular, in some examples the controller can be programmed to display the calculated flame temperature on an electronic display. In various examples, the display can be a computer monitor, an LCD screen, OLED screen, a digital LED display, or another type of display.

### EXAMPLES

### Example 1

A temperature sensor as described above was applied to in situ plume measurements with small fiberoptic cables inserted into the rocket motor fuel grain and routed to “look” directly into the plume core flow. Preliminary tests performed demonstrated that fiberoptic cable cured into ethylene propylene diene monomer (EPDM) rubber (typically used as an insulator in solid rocket systems) does continue to transmit light as it is subjected to the flame of an oxyacetylene torch. A sample fiberoptic cable routed through an EPDM sample was burned with a torch, and the melted tip was still able to transmit light through the fiber. This demonstrated a high probability that the fiberoptic connection would continue to operate in a real combustion chamber environment.

The fiberoptic cables transmits thermal radiation from the plume to an external Hamamatsu miniature spectrometer. As the solid fuel surface regresses, the exposed tip of the fiberoptic cable burns away, so that the tip of the cable stays flush with the fuel boundary. The output from the spectrometer was run through a signal processing board that could be connected to a laptop by a USB for data collection. The testing campaign also indicated that the burning of the fiberoptic cable itself did not have a notable impact on the resulting spectral data.

A more advanced follow-on experiment demonstrated the effectiveness of the system in a hybrid rocket combustion chamber. In this testing campaign a well-characterized 100-N, 75-mm thruster system was modified to allow the fiber optic cables to be fed into the thrust chamber. FIG. 8 shows this thrust chamber arrangement with the two fiberoptic cables routed through the injector cap, along the outer fuel grain wall and into the fuel port. The figure also shows 2 cables routed through the aft end, but data from these was not successfully collected as the cables reliably did not survive to transmit data for the whole burn. The test rocket burned gaseous oxygen (GOX) and Acrylonitrile Butadiene Styrene (ABS) as propellants.

A total of 5 successful hot fires with burn durations varying from 5 to 25 seconds were performed in this configuration. Although temporary saturation of the sensors was experienced at the burn initiation, the fiberoptic sensors survived for all of the hot fire tests, and both rocket performance and in situ optical data were successfully collected for each of the 5 tests. This data was primarily qualitative in nature, due to many factors including, but not limited to, a lack of calibration in the spectrometers, lack of understanding of the effect of the fiberoptic cables on the spectral data, and a small enough data set so as not to be statistically proven.

The spectrometer used during the research had an operating range covering parts of the visible and infrared spectrum, from approximately 640 to 1050 nm. A new spectrometer was acquired with a range of 340 nm to 850 nm, allowing the sensor to detect light further into the ultraviolet range. This spectrometer was purchased from Hamamatsu. This spectrometer captures the visible light range well. However, it is easily oversaturated by the intense light of the combustion chamber, the software only allows for limited control of the instrument, and the spectrometer does not capture data from the infrared range. This oversaturation requires physical attenuators to be used in the fiberoptic system leading to the spectrometer.

A series of in-line optical attenuators were procured and connected between the optical fiber and the spectrometer. These multimode fixed fiber optic attenuators conveniently allow an optical signal to be attenuated by plugging multimode fibers directly into the attenuator. The attenuation is controlled by increasing the air gap between the two connectors, which decreases the coupling efficiency. Gap distances varying from 0.2 mm to 5.8 mm were used, allowing different levels of attenuation to be achieved depending upon the test conditions and fiber optic cables being used. The need for attenuation varied depending on the type of cable used and the spectrometer used to collect the data.

The results of this testing were varied, and the effect of the attenuators and the extra fiberoptic cable extensions (which were often different types of fiberoptic cables) made it difficult to properly calibrate the system. The qualitative data from the spectrometer was good, but the value of the quantitative data was variable and unreliable when compared to later data with different spectrometers. Once a better spectrometer was acquired, the Hamamatsu spectrometer data was considered unreliable.

Before discussing the testing campaign for this research, some theoretical analysis is considered. This analysis describes how the wavelength range of interest was calculated, the method of optical analysis used on the spectrometer data, the motor performance analysis calculations, and the shift in oxidizer to fuel (O/F) ratio experienced during the burn of a hybrid rocket motor.

The primary fuel used for the testing campaign is ABS, which is a terpolymer (a polymer made up of 3 monomers). The 3 monomers in ABS are acrylonitrile, butadiene, and styrene. The monomer mass fractions of each monomer in the plastic can vary, and the precise chemical formulas of the various commercially available feed stocks and extruded rods of ABS are tightly guarded proprietary data of their manufacturers and are not readily available in the public domain. Therefore, to perform plume contamination studies, the general chemical makeup (including monomer mass and mole fractions, molecular weights, and enthalpies of formation and polymerization) was first be measured or estimated.

Fourier Transform Infrared (FTIR) spectroscopy tests were performed to estimate the relative monomer proportions of both the 3-D printed (Stratasys ABSPlus-340) and extruded (McMaster-Carr) ABS fuel materials. The specific technique used for the FTIR evaluation is known as Attenuated Total Reflection (ATR). ATR works by directing an IR beam at an angle into an optically dense crystal with a high refractive index. The beam passes through the crystal to contact the sample placed on top of it. The sample will absorb certain wavelengths of the IR beam, which is then reflected back through the crystal and into a spectrometer. The resulting spectrum can be used to tell how much of which wavelengths were absorbed by the sample. Since the infrared penetration is only a few microns, ATR is reasonably independent of sample thickness.

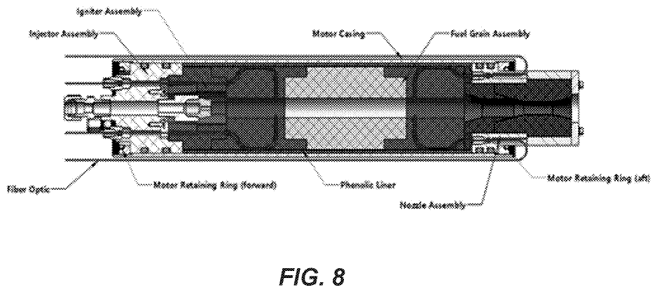

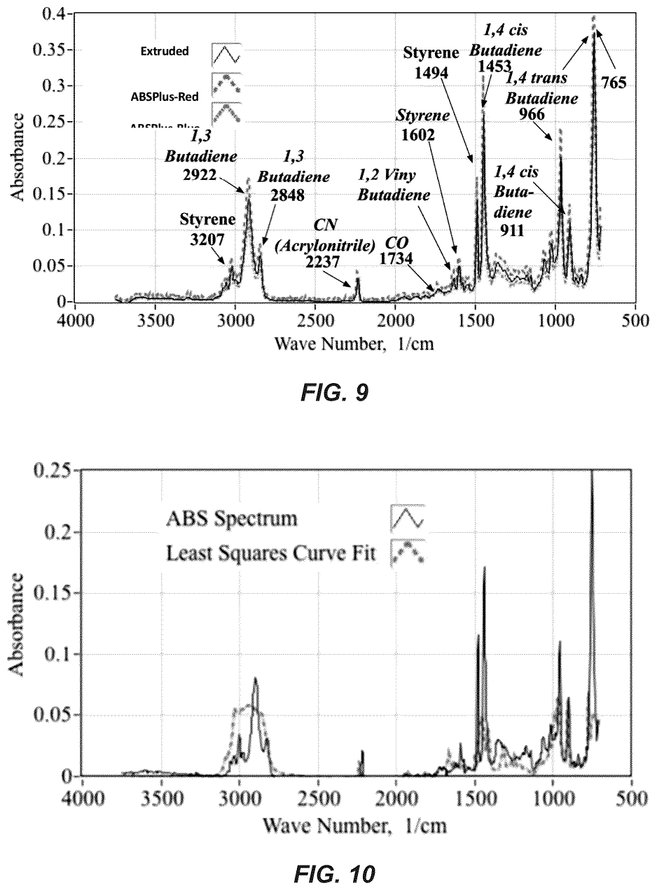

FIG. 9 shows the ATR absorbance spectra collected for 2 Stratasys ABS Plus samples (red and blue) and 1 extruded ABS sample (beige). The absorbance level in fraction of absorbed power is plotted against the wave number in cm-1. The identifications and corresponding wave numbers of major peaks are annotated. The 3 spectra are more than 93% correlated, indicating the samples are of very similar composition.

In order to estimate the mass proportions of each monomer in the feedstock material, the ensemble spectrum from FIG. 9 was curve fit to reference spectra for acrylonitrile, butadiene, and styrene, assuming a linear model in which

$$\text{?} ( n ) = a \text{?} ( n ) + b \text{?} ( n ) + c \text{?} ( n )$$

$$\text{?} \text{indicates text missing or illegible when filed}$$

the respective absorbances of acrylonitrile, butadiene, and styrene monomers are independent variables, where each absorbance is multiplied by a coefficient (a, b, c), and the spectrum in FIG. 9 as the dependent variable. The best fit coefficients {a, b, c} are evaluated for each wave number to give the overall minimum squared error between the measured ABS spectrum, and the model. FIG. 10 compares the least-squares curve fit model against the ensemble spectrum for the red ABS Plus feedstock. The resulting fit exhibits a correlation coefficient of approximately 0.85 and is deemed to be statistically significant.

The resulting mass proportions for the best fit model of FIG. 10 are: acrylonitrile 28.4%, butadiene 41.1%, and styrene 30.5%. Based on the estimated mass percentages, and the associated molecular weights of the 3 ABS monomers, the corresponding mole-fractions are: acrylonitrile 33.7%, butadiene 47.9%, and styrene 18.4%. The corresponding chemical formula is C_{4.399}H_{5.357}N_{0.337}. Table 1 lists the enthalpy contributions for each of the ABS copolymers including the monomer enthalpy of formation ΔH_{f} and energy required for depolymerizing a particular monomer from the polymer chain ΔQₚ. Table 1 also lists the ABS material chemical formula and molecular weight Mw. The total enthalpy of the polymer is less than the sum of the enthalpies of the individual monomers and the net enthalpy contribution of each monomer given by the difference between ΔH_{f} and ΔQₚ. Since the polymer reaction is exothermic, ΔQₚ must be returned to the fuel material in order to break the polymer bonds, and that energy is not available to support the combustion reaction.

TABLE 1
Chemical properties of monomers in ABS samples

| | | | ΔH_{f} | ΔQₚ | Net | | | Net Enthalpy |
|---|---|---|---|---|---|---|---|---|
| | Chemical | Mw | monomer | polymer | ΔH_{f} | Mole | Mass | Contribution |
| Monomer | Formula | g/mol | kJ/g-mol | kJ/g-mol | kJ/g-mol | Fraction | Fraction | kJ/g-mol |
| Acrylo- | C₃H₃N | 53.06 | 172.62 | 74.3 | 98.31 | 0.337 | 0.284 | 33.13 |
| nitrile | | | | | | | | |
| Butadiene | C₄H₆ | 54.09 | 104.10 | 72.10 | 32.00 | 0.479 | 0.411 | 15.33 |
| Styrene | C₈H₈ | 104.15 | 146.91 | 84.60 | 63.31 | 0.184 | 0.305 | 11.65 |
| ABS | C_{4.399} | 62.95 | | | | 1.00 | 1.00 | 60.11 |
| Total | H_{5.357} | | | | | | | |
| | N_{0.377} | | | | | | | |

The enthalpy and molecular weight estimates from Table 1 were used to calculate the theoretical equilibrium combustion properties of ABS and GOX as a function of oxidizer: fuel ratio (O/F). The thermochemical calculations were performed using the industry standard NASA Chemical Equilibrium with Applications (CEA) tool. These calculations assume the 3-D printed fuel is burned at 100% efficiency with GOX at various O/Fs, and combustion chamber pressure P₀ is allowed to vary across a range of useful combustion pressures for the GOX/ABS propellants. The CEA analysis predicts stoichiometric O/F ratio to be approx. 2.89. The equivalence ratio Φ is defined as the stoichiometric O/F ratio divided by actual O/F ratio.

The theoretical characteristic velocity c* and flame temperature To were calculated as a function of both O/F and Φ assuming 100% combustion efficiency, η*. Different P₀ values were also used, varying from approx. 1000 kPa (145 psia) to 6000 kPa (870 psia) in 1000 kPa (145 psi) increments. Higher To and c* are associated with higher P₀. It was found that a narrow operating range exists over which near optimal performance is achieved. This range is approximately 1.25 to 2.25 O/F, or 1.28 to 2.3 equivalence ratio.

These values for ABS/GOX combustion were used to determine the predicted gas temperature and composition at the thruster exit. Using the 1-D isentropic de-Laval flow equations, the T₀ values of FIG. 7 can be used to estimate nozzle exit gas temperatures. The nozzle gas temperature was calculated for 4 low-to-moderate nozzle expansion ratios: Aₑₓᵢₜ/A*={2.0, 4.0, 6.0, and 8.0} (assuming η*=100%). During adiabatic expansion through the nozzle, the maximum gas temperature drops from a range of 3250-3550° C. at the combustor, to a range of 2000-2150° C. at the nozzle exit (expansion ratio 8.0). The nozzle exit gas temperatures were also calculated assuming η*=95%. This drop in η* causes the nozzle exit temperatures to drop between 20° and 300° C.

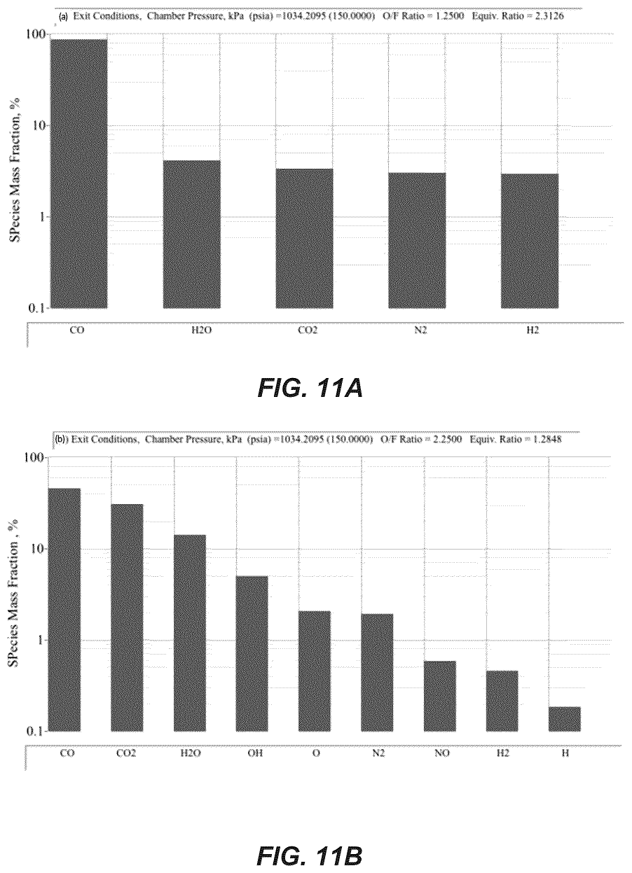

The CEA code also calculates the plume species concentrations for various chamber pressures and O/F ratios. FIG. 11A and FIG. 11B show the resulting GOX/ABS exhaust plume mass concentrations at the limits of the near optimal O/F range, from 1.25 to 2.25, at a chamber pressure of 150 psia (1034 kPa), a mid-range operating pressure for the 75-mm hybrid motor.

For this calculation, the motor is running moderately fuel rich, but not so fuel rich condensable graphite (soot) is produced. This species C (gr), is highly condensable and deposition of soot on test stand surfaces is common, especially for fuel rich burns and at low throttle levels. C(gr) is a potential contamination source, so ABS hybrid motors should not be operated at equivalence ratios above approximately 2.5 for optical research.

This analysis clearly shows the resulting species concentrations from GOX/ABS combustion are strongly dependent upon the motor's operating equivalence ratio. At the fuel rich limit of the near optimal equivalence ratios, the dominant plume species are CO, CO₂, H₂O, N₂, and H₂. As the motor runs slightly leaner, concentrations of N₂, and H₂ diminish and other less-dominant species including hydroxyl (OH), nitric oxide (NO), and atomic oxygen (O) begin to appear.

The Planck radiation law was used to calculate black body radiation curves corresponding to the combustor and the nozzle exit for 8 different O/F ratios near the optimal operating point, with O/F={1.5, 1.75, 2, 2.25, 2.5, 2.75, 3.0, and 3.5}. The nozzle calculation assumes η*=100% and expansion ratio A/A*=4.0. The same curves were then calculated again, but with η*=95%. This produced a redshift as the O/F ratio changed. It was found that near the optimal operating point, the shapes of the blackbody curves for both the combustor and the nozzle exit, are not significantly affected by O/F, with only a slight redshift of the curve to the right at the lowest O/F ratios. The gas cooling associated with expansion through the nozzle has the effect of significantly shifting the blackbody curve to the right. Also, the effects of combustion efficiency are minor, shifting the peak frequency right by less than 50 nm.

From Wien's displacement law, the wavelength associated with the intensity at a given gas temperature is shown in equation 2 above. The maximum intensity wavelengths for both the combustion chamber and nozzle exit were calculated as a function of O/F and the 4 expansion ratios (A/A*=2, 4, 6, and 8). The peak intensity wavelengths for the combustion chamber lie just outside the visible light range, in the near infrared light spectrum, with peak intensity wavelengths ranging from approx. 810 nm-840 nm at 100% combustion efficiency, and from 900 nm-930 nm at 95% combustion efficiency. In contrast, the peak intensity wavelengths for the nozzle exit lie well into the mid-infrared spectrum with peak-intensity wavelengths ranging from approx. 1040 nm-1400 nm at 100% efficiency, redshifting to a range of 1260 nm to 1710 nm at 95% efficiency.

These results show that much of the combustion chamber radiation spectrum, including the peak-intensity wavelengths, lie well within the visible-to-near-infrared wavelength range. In contrast, the emission spectrum from the nozzle lies mostly in the low-to-mid infrared range. Similarly, three of the dominant combustion species, H₂O, N₂, and O have dominant emission frequencies that lie well within the visible light range. However, two other dominant species CO and CO₂ have emission wavelengths that lie well deep in the infrared spectral range. Table 2 shows the predominant emission wavelengths associated with each of these species.

TABLE 2
Emission wavelengths of plume exhaust species

| | Mass | |
|---|---|---|
| Species | Fraction | Emission Wavelengths (nm) |
| CO | 59.8% | 1568, 2330, 4610 |
| H₂ | 23.5% | 410, 434, 486, 656 |
| H₂O | 8.3% | 1380, 1870, 2700 |
| H | 3.0% | 410, 434, 486, 656 |
| CO₂ | 2.8% | 300, 444, 1459 |
| N₂ | 2.1% | 590, 670, 740, 820, 870, 900, |
| | | 970 |
| OH | 0.4% | 304, 307 |
| O | 0.03% | 558, 630, 635 |
| C | Nozzle soot | 687, 904 |

These results suggest that a single spectrometer may not sense the entire spectral range of interest for the GOX/ABS hybrid motor. At least two spectrometers, one fine-tuned for visible and near-infrared wavelengths, and one tuned for mid-to-deep infrared wavelengths can be used to sense the entire combustion spectrum.

Thus, the research presented in this example places a main emphasis on sensing the combustion chamber data, including flame temperature and species identification and concentrations for the visible-wavelengths of H₂O, N₂, H, and O.

The analytical methods used to calculate key motor performance parameters from raw test data are explained below. These calculations include fuel mass flow rate, oxidizer-to-fuel ratio, equivalence ratio, specific impulse (Isp), and characteristic velocity. An inline Venturi flow meter directly measures the oxidizer flow rate in real-time; however, the test stand does not directly measure fuel mass flow. Instead, the fuel grains are weighed before and after each hot fire to measure total fuel mass consumed during the test. These mass measurements are used to anchor the “instantaneous” fuel mass flow rates, which are calculated as the difference between the total nozzle exit flow and oxidizer mass flows, described in equation 9.

$${\dot{m}}_{f u e l} ( t ) = {\dot{m}}_{t otal} ( t ) - {\dot{m}}_{o x} ( t ) \qquad ( 9 )$$

The total nozzle exit flow is calculated using the 1-dimensional choking mass flow equation, equation 10. Since the nozzle throat area (A*) is known and the plume exhaust gas properties can be calculated by CEA, the total nozzle exit mass flow can be calculated from the measured chamber pressure (P₀). Equation 10 assumes the flow composition is no longer changing at/after the nozzle entrance, and the nozzle is not eroding (the nozzle erosion is negligible for these tests). This calculation is made at each point of collected data over the history of the burn. For each point, the plume exhaust gas properties (gas constant R_{g}, ratio of specific heats y, and flame temperature T₀) are interpolated from the tables of thermodynamic and transport properties from the CEA analysis, with chamber pressure P₀ and mean O/F as the lookup variables.

$${\dot{m}}_{total} ( t ) = {A}^{*} \cdot {P}_{0} ( t ) \cdot \sqrt{\frac{γ}{{R}_{g} \cdot {T}_{0}} \cdot {( \frac{2}{γ + 1} )}^{\frac{γ + 1}{γ - 1}} \vert} \qquad ( 10 )$$

Calculating the flame temperature starts with defining the combustion efficiency, as in equation 11.

$${η}^{*} = \frac{{c}_{actual}^{*}}{{c}_{ideal}^{*}} = \frac{\sqrt{{( \frac{γ + 1}{2 \cdot γ} )}^{\frac{γ + 1}{( γ - 1 )}} {R}_{g} \cdot {T}_{{0}_{actual}}}}{\sqrt{{( \frac{γ + 1}{2 \cdot γ} )}^{\frac{γ + 1}{γ - 1 )}} {R}_{g} \cdot {T}_{{0}_{ideal}}}} \approx \sqrt{\frac{{T}_{{0}_{actual}}}{{T}_{{0}_{ideal}}}} \qquad ( 11 )$$

The theoretical flame-temperature from CEA is scaled to a more realistic value by adjusting the combustion efficiency as in equation 12.

$${T}_{{0}_{actual}} = {η}^{* 2} \cdot {T}_{{0}_{ideal}} \qquad ( 12 )$$

Equations 9-12 are iterated, adjusting η* after each iteration, until the consumed fuel mass (calculated as the integral of equation 9 over the burn duration) matches the burned fuel mass (calculated from the pre- and post-test fuel weight measurements) within 1% accuracy. The combustion efficiency is increased to increase the calculated fuel consumption or vice versa.

The instantaneous O/F ratio is then calculated as measured oxidizer mass flow divided by this calculated fuel mass flow.

With total mass flow known, specific impulse and characteristic velocity are calculated as shown in equations 13 and 14, using the measured thrust and chamber pressure readings.

$${I}_{sp} = \frac{{F}_{thrust}}{{g}_{0} {\dot{m}}_{total}} \qquad ( 13 )$$

$${c}^{*} = \frac{{P}_{0} \cdot {A}^{*}}{{\dot{m}}_{total}} \qquad ( 14 )$$

The test stand is set up to measure thrust, which can also be calculated using the 1-dimensional de Laval flow equation in equation 15.

$${F}_{thrust} = {P}_{0} {A}^{*} \cdot ( \begin{matrix}\sqrt{\frac{2}{γ - 1} \cdot {( \frac{2}{γ + 1} )}^{\frac{γ + 1}{γ - 1}}} {( 1 - \frac{{p}_{exit}}{{P}_{0}} )}^{\frac{γ - 1}{γ}} + \\ ( \frac{{A}_{exit}}{{A}^{*}} ) ( \frac{{p}_{exit} - {p}_{∞}}{{p}_{0}} )\end{matrix} ) \qquad ( 15 )$$

In equation 15 pₑₓᵢₜ is the nozzle exit pressure calculated from the nozzle expansion ratio and chamber pressure, and po is the operating ambient pressure.

Comparing the measured thrust and calculated thrust is a good indicator of the mass flow and O/F ratio calculation accuracy.

The operating environment of a hybrid rocket motor is different from a solid rocket motor in several ways. For a solid motor, the O/F ratio is pre-set and precisely controlled by the formulation of the propellent during mixing and casting. A slightly fuel rich burn (lower O/F ratio) gives the optimal characteristic velocity (c*) performance and reduces highly reactive and potentially erosive unburned oxygen radicals in the exhaust plume. The linear rate of fuel pyrolysis is a strong function of combustion chamber pressure and is typically modeled using St. Robert's law, equation 16.

$$\dot{r} = a \cdot {P}_{0}^{n} \qquad ( 16 )$$

In equation 16, P₀ is the combustion chamber pressure, and the parameters a and n are empirically determined. St. Robert's law allows for a significant coupling between the solid propellant burn rate and the chamber pressure.

In contrast, the combustion process for hybrid motors primarily depends on oxidizer mass flux and associated friction phenomena within the developing boundary layer. As the fuel grain burns, the interior diameter increases and the O/F ratio changes throughout the motor burn. Multiple studies have demonstrated hybrid fuel regression rates have very low levels of pressure coupling.

The combustion process for hybrid motors, and the associated fuel pyrolysis rates, are primarily driven by viscous heat transfer within the boundary layer. Thus, fuel regression rate is strongly correlated with mass flux through the combustion chamber fuel port. Marxman and Gilbert posed a length dependent “Saint-Roberts” type of power-law model of the form, in equation 17.

$${\dot{r}}_{L} = \frac{a \cdot {G}_{ox}^{n}}{{L}^{m}} \qquad ( 17 )$$

In equation 17, L is the longitudinal distance down the fuel port axis, r_{L} is the longitudinal mean of the fuel regression rate, Gₒₓ is the oxidizer mass flux down the fuel port, and a and n are empirically determined constants. The fuel massflow rate is calculated from fuel regression rate by equation 18.

$${\dot{m}}_{fuel} = {ρ}_{fuel} \cdot {A}_{burn} \cdot {\dot{r}}_{L} \qquad ( 18 )$$

The initial studies with nitrous oxide and hydroxyl-terminated polybutadiene (HTPB) as propellants predicted values for n~0.8, and m~0.2 for the parameters of equation 17. However, for other propellant combinations, these parameters can have significant variations. Though results of many regression rate tests have shown the power law form of Marxman's regression rate law valid for non-erosive burning, there is currently no comprehensive, first principal theory that can be used to reliably predict this quantity over a range of motor sizes and propellants.

Due to the mass flux coupling from equation 17, hybrid motors undergo a continual O/F ratio shift as the fuel grain interior surface area increases. Assuming the power law regression rate model from equation 19, show for a cylindrical hybrid fuel port the instantaneous longitudinal mean of the O/F ratio can be written as equation 19.

$$O / F = ( \frac{1}{{4}^{n} \cdot {π}^{1 - n}} ) \cdot ( \frac{{\dot{m}}_{ox}^{1 - n}}{a \cdot {ρ}_{fuel}} ) \cdot ( \frac{{D}^{2 n - 1}}{{L}^{m + 1}} ) \qquad ( 19 )$$

From equation 19, as port diameter increases over the burn, n determines the O/F shift. Depending on the burn exponent n, the O/F ratio can either shift from lean to rich or vice versa. If the burn exponent n>1/2, the O/F ratio experiences a positive shift and the motor burns increasingly leaner with time. When the burn exponent is exactly equal to 1/2, the burn is neutral and the motor experiences no O/F shift. Finally, when the burn exponent n<1/2, the motor burns increasingly fuel rich with time, and the O/F shift is negative. This can drastically change the observed burn profile. With a constant oxidizer massflow, a positive O/F shift motor will generally see a drop off in thrust as the motor burns, and a negative O/F motor will experience an increase of thrust with time.

A linear analysis demonstrates this effect. Writing the O/F ratio as the ratio of oxidizer and fuel massflow rates, in equation 20,

$$O / F = \frac{{\dot{m}}_{ox}}{{\dot{m}}_{fuel}} \qquad ( 20 )$$

for a cylindrical-fuel port, (equation 21)

$${\dot{m}}_{fuel} = {ρ}_{fuel} \cdot ( {A}_{burn} ) \cdot \dot{r} = {ρ}_{fuel} \cdot ( 2 π \cdot {r}_{port} \cdot L ) \cdot \dot{r} \qquad ( 21 )$$

allowing m~1−n, and substituting exponential regression rate law of equation 22

$$\dot{r} = a \cdot {G}_{ox}^{n} \cdot {L}^{1 - n} \qquad ( 22 )$$

and equation 23:

$$O / F = \frac{{\dot{m}}_{ox}}{{ρ}_{fuel} \cdot ( 2 π \cdot {r}_{port} \cdot L ) \cdot {a ( \frac{{\dot{m}}_{ox}}{π \cdot {r}_{port}^{2}} )}^{n} \cdot {L}^{m}} = \frac{{\dot{m}}_{ox}^{1 - n} \cdot {r}_{port}^{2 n - 1}}{{ρ}_{fuel} \cdot ( 2 {π}^{1 - n} \cdot a ) {L}^{1 + ( 1 - n )}} = \frac{{\dot{m}}_{ox}^{1 - n} \cdot {r}_{port}^{2 n - 1} \cdot {L}^{n}}{{ρ}_{fuel} \cdot ( 2 {π}^{1 - n} \cdot a )} \qquad ( 23 )$$

calculating the derivative of O/F with respect to time, (equation 24)

$$\frac{\partial ( O / {F}_{( t )} )}{\partial t} = ( \frac{{\dot{m}}_{ox}^{1 - n}}{{ρ}_{fuel} \cdot ( 2 {π}^{1 - n} \cdot α ) {L}^{n}} ) \frac{\partial ( {r}_{port}^{2 n - 1} )}{\partial t} = ( \frac{{\dot{m}}_{ox}^{1 - n}}{{ρ}_{fuel} \cdot ( 2 {π}^{1 - n} \cdot α ) {L}^{n}} ) \cdot ( ( 2 n - 1 ) \cdot {r}_{port}^{2 n - 2} \cdot \dot{r} ) = ( \frac{( 2 n - 1 ) \cdot {\dot{m}}_{ox}^{1 - n}}{{ρ}_{fuel} \cdot ( 2 {π}^{1 - n} \cdot α ) {L}^{n}} ) \cdot {r}_{port}^{2 ( n - 1 )} \cdot [ α {( \frac{{\dot{m}}_{ox}}{π \cdot {r}_{port}^{2}} )}^{n} \cdot {L}^{n - 1} ] = ( \frac{( 2 n - 1 ) \cdot {\dot{m}}_{ox}}{{ρ}_{fuel} \cdot ( 2 π \cdot {r}_{port}^{2} ) \cdot L} ) = ( \frac{( 2 n - 1 ) \cdot {\dot{m}}_{ox}}{{ρ}_{fuel} \cdot {( {V}_{ol} )}_{port}} ) \qquad ( 24 )$$

and substituting the concatenated burn exponent from Table 2, (equation 25)

$$\to {n}_{concat} = 0 \text{.332} \qquad ( 25 )$$

$$( a ) O / {F}_{( t )} = \frac{{\dot{m}}_{ox}^{668} \cdot {L}^{0.336}}{{ρ}_{fuel} \cdot ( 2 {π}^{1 - n} \cdot a ) \cdot {r}_{( t ) port}^{0.336}}$$

$$( b ) \frac{\partial ( O / {F}_{( t )} )}{dt} = - 0.3 \; 36 \cdot ( \frac{{\dot{m}}_{ox}}{{ρ}_{fuel} \cdot {( {V}_{{ol}_{( t )}} )}_{port}} ) .$$

Then, from equation 25 (a) it is observed that O/F ratio decreases with time as the fuel port burns and the port radius increases. However, from equation 25 (b) it is also observed that the rate of decrease will diminish with time as the fuel port radius and internal volume grow during the burn lifetime.

One of the challenges for this project was finding the best spectrometer and the best fiberoptic cable for the wavelengths of interest. This section covers the selection of the best fiberoptic cables, spectrometers, spectrometer calibration method, and the test motor and instrumentation assembly.

There are many different types of fiberoptic cables, optimized for a wide variety of uses. The fiberoptic cable itself is composed of 2 layers, the inner core where the light travels, and the cladding which acts like a mirror, reflecting the light to keep in contained within the core. Thus, these components guide the light introduced at one end of the cable through to the other end by the principle of total internal reflection, which is the reflection of all light incident upon a boundary. This works because the index of refraction of the core glass is higher than the cladding. The glass fibers are clad in a protective layer of acrylic, with tensile members, usually Kevlar, to increase the strength and reduce light loss along the cable. The transmitted light stays confined to the core because the cladding has a lower refractive index than the core fiber.

The standard cheap cable used for the initial tests turned out to be optimized for 850-1300 nm light. This was realized after the new Hamamatsu spectrometer did not see any notable light through this cable, due to its range topping out at 850 nm. This means previous data was likely skewed by this transmissibility problem. The previous spectrometer used during the tests could see up to 1050 nm light, (and was not calibrated by wavelength) so the problem had previously gone unnoticed.

Due to this discovery, more types of fiber optic cable were explored. The major types of fiber optics explored are discussed here followed by an analysis of which tested cables were most useful. The fiberoptic cable used in the previous research was discarded as it did not transmit the wavelengths of interest well.

Single mode cables consist of single glass fibers with diameters between 5 and 10 micrometers. The narrow diameter allows only a single wavelength to propagate through the fiber. In allowing only a very narrow wavelength band to travel through the cable, the fiber can be used for very high transmission bandwidths, and these types of cables are used primarily for high-speed data propagation.

The standard transmission single-mode wavelengths are 1310 or 1550 nm, and most cables are optimized for one of these wavelengths, transmitting them with the lowest attenuation. This low attenuation is why single mode fiberoptic is preferred for long distance transmission applications.

Multimode fibers have a significantly larger core diameter than single mode, with core diameters up to 600 micrometers or more. The larger core diameter allows multiple wavelengths of light to travel down the core simultaneously and a greater total amount of light to be propagated through the cable. Importantly, multimode fibers offer a significantly greater coupling efficiency (where optical coupling efficiency is defined as the fraction of available output from a radiant source that is coupled and transmitted by an optical fiber). In addition, multimode fibers are generally more rugged than single mode fibers, allowing smaller bend-radii, and they are more resistive to strain-damage.

Multimode fiber comes in two forms, graded index, and step index. The graded index fiber core has a refractive index that monotonically drops from the fiber center, radially outwards toward the outer cladding. The higher refractive index at the center slows the propagation of the light moving down the center axis relative to light near the outer cladding. Thus, rather than bouncing off the cladding, light in the core moves directly down the optical axis. This effect reduces the light travel distance, and the shortened core path combined with the higher light speed at the periphery, allows the various light wavelengths to arrive at a receiving end of the fiber closer to the same time. This effect significantly reduces digital pulse distortion, a key advantage for digital data transmission. The other form of multimode fiberoptic, step index fiber, has a rather uniform core index of refraction that increases significantly near the outer cladding. As a result, some of the light rays travel a direct route, whereas others bounce off the cladding. The associated alternative pathways caused by the gradient forces the different groupings of light rays to arrive separately at the receiving point. This mixed arrival time has the effect of distorting the transmitted light pulse. This distortion means that there exists a need to space the pulses to prevent signal overlapping. This spacing then limits the transmission bandwidth that can be achieved.

In both forms of multimode fiberoptic, the different wavelengths of light entering the fiber travel slightly different paths, meaning the signal can be distorted, and making these cables less useful for data transmission. This is why single mode cables are preferred for modern communication systems. In spite of this performance deficit for communication systems, multimode fibers are well-suited for spectroscopy applications. For this spectroscopy application, pulse distortion and transmission frequency are not an issue as long as a representative sample of light within the wavelength band of interest is transmitted. In this case, step index multimode fiber has advantages that make it a good candidate. Step index fibers are generally more rugged than graded index fibers, allowing smaller bend radii, and they are more resistive to strain damage. Due to the lower core index of refraction, step index fibers also have a significantly greater coupling efficiency as compared to gradient index fibers. Thus, step index fibers allow significantly more light passage with lower attenuation, than similarly sized graded index core. Finally, step index fibers are generally much cheaper to produce than gradient index fibers.

Plastic optical fibers (POFs) are a recent development, fabricated using clear plastics (typically polymethyl-methacrylate). POFs are nearly an order of magnitude cheaper to produce than glass fibers. Due to the plasticity of the fiber, they are also rugged and easy to install with less susceptibility to damage than glass fibers. These fibers feature a significantly larger core diameter than glass fibers, with diameters of up to 1,000 micrometers. The large core size significantly increases coupling efficiency and connections need not be high precision.

While the fiber can still transmit more overall light than glass fibers, POF still technically has higher attenuation over distance and a lower transmission bandwidth. It still works well for applications needing to transmit a high level of light over a short distance, as is desired here. Initially, the high amount of light transmitted actually proved a problem for testing, as enough light was transmitted to saturate the sensor. This problem has been mitigated by having acquired a spectrometer that can control exposure time. The plastic fiberoptic actually does a better job than multimode cable at burning away during the test in the fuel grain. However, the calibration graphs show some abnormalities in the transfer function, and this particular plastic cable was rejected for future tests due to unreliability.

Table 3 lists the most promising fiberoptic cables tested over the course of the research. The cables will be referred to by color rather than part number herein to make them easier to keep track of.

TABLE 3
List of tested fiberoptic cables

| Cable | | Core | Transmission | Fiber | |
|---|---|---|---|---|---|
| Type | Part Number | Diameter | Wavelengths | NA | Color |
| Multi- | Newport F-MBC | 400 μm | 500-1100 nm | 0.37 | clear |
| mode | Thor Labs | 600 μm | 300-1200 nm | 0.39 | blue |
| | FT600UMT | | | | |
| | Thor Labs | 400 μm | 400-2200 nm | 0.39 | blue with |
| | FT400EMT | | | | orange |
| | | | | | connector |
| POF | Newport | 980 μm | 400-1000 nm | 0.58 | black |
| | F-POF-1000-C | | | | |

Following is a description of each of the table parameters. The part number is the identification used for that cable on the website it was bought from. The core diameter is the diameter of the cable itself, without any cladding. The transmission wavelengths are the stated range of wavelengths the cable will transmit best. The numerical aperture (NA) of a fiber cable, defined as the sine of the largest angle of incident ray that can be fully captured by the fiber core, is a measure of the acceptance angle of the fiber cable. The largest acceptance angle is based on the critical angle, as light must hit a boundary at an angle greater than the critical angle in order to propagate through total internal reflection. A fiber with a higher NA allows for light transmission over a larger range of wavelengths. NA is also an important parameter that determines how well a fiber guides light and its resistance to bending losses. For the proposed plume-sensing application, the NA also determines how diffuse the measurement becomes. A fiber optic with a larger NA can “see” a wider region of the flow, where a small NA fiber yields more of a pinpoint measurement. The color is the color of the cable or outer cladding, much easier to keep track of during testing than the part number.

Each of these cables was used for various tests and had different properties, described in the following sections.

### Blue Cable (Thor Labs FT600UMT Multimode Step Index Fiberoptic Cable)

The blue cable was found to work best for the nozzle insertion setup. It lasts the longest in high temperature and can simply be trimmed and adjusted every burn or two. This tendency to burn away slower makes it less suitable for measurements in the combustion chamber where it can become blocked by soot and may not stay flush with the wall of the fuel grain. In very small motors, the protruding tip could break off and block the nozzle. This cable is by far the most resilient and is relatively difficult to damage or break. It also attenuates more than the other cables, which is actually helpful with the amount of light being transmitted.

### Clear Cable (Newport F-MBC Multimode Step Index Fiberoptic Cable)

The clear cable has been the primary candidate for use in the combustion chamber. It burns away better than the blue cable, though it still protrudes somewhat into the fuel grain after the burn and can become blocked. This cable is not as sturdy as the blue fiberoptic, and after use small stress fractures are visible in the cable, though it continues to transmit light well as long as it has not snapped.

### Black Cable (Newport F-POF-1000-C Plastic Fiberoptic Cable)

The black cable does the best at burning away in the combustion chamber and staying flush with the edge of the fuel grain. Initially it transmitted so much light the spectrometer could not “see” a useful signal. Once this problem was solved, calibration showed a concerning dip around 750 nm making the data less reliable.

The other difficulty with the black fiber is it is too thick to fit through the adapters used to connect to the spectrometers without removing the coating. The inner plastic is not a convenient size to use wire strippers on, so the coating ends up removed with a knife, which leaves dings and scrapes in the cladding.

### IR Cable (Thor Labs FT400EMT Multimode Step Index Fiberoptic Cable)

This is the cable that had the best transmissible range to be used with the IR spectrometer. Thor labs conveniently provides lengths of it with a spectrometer adapter already attached, removing the need to install the adapter onto the cable, making the cut on the end of the cable much more even than the other cables cut by the lab. Technically, due to the range of wavelengths this cable is rated for, it could be tried as a visible light cable as well, but this was not tested.

The selection of the spectrometer was primarily based on the wavelength range of interest, and the ability to easily connect the fiberoptic cable. The emission wavelengths of light expected from the primary chemicals produced in the combustion plume were predicted as explained above.

Some species, like carbon monoxide, have emission spectral well into the infrared. Most of the other species have emission bands within the visible light range. Two spectrometers have been acquired that have provided reliable data. The LR-1 spectrometer from ASEQ Instruments detects light in the visible range, and the Broadcom Qneo spectrometer detects light in the infrared range.

The LR-1 spectrometer has a stated range of 200-1200 nm. Unfortunately, while the range is stated to extend to 1200 nm, the spectrometer actually shows very little of the light above about 900 nm.

To its credit, the LR-1 spectrometer can be controlled by a Lab VIEW VI rather than just the manufacturer's software, which was a problem with the Hamamatsu spectrometer mentioned in section 2.3.2. This allows the exposure time of the spectrometer to be carefully controlled and adjusted for the varying intensities of the different flow regions.

The Qneo spectrometer also has this capability and both spectrometers are controlled through LabVIEW VIs so the settings can be changed as needed for each test burn. The Qneo range is 950 nm-1700 nm.

This combination of spectrometers allows for a range of data collection that one spectrometer alone would not be able to cover. The range can cover the Planck's law peak for the chamber temperatures of interest.

Radiometric calibration of the optical system is used to determine the spectrometer/fiberoptic system transfer function, which allows the blackbody response curve to be derived from the sensed spectra using the Wiener filtering calibration as described above.

The spectrometers were calibrated by using them to inspect a known tungsten light source from Thorlabs. This light source has been carefully calibrated to deliver a known spectrum of light with low uncertainty. The spectrum for this light will be further discussed in the calibration results below. The red tungsten light is connected to the spectrometer by the fiberoptic cable.

For the visible light calibration a series of bandpass filters with center band wavelengths of 450, 550, 650, 750, 850, and 1000 nm, were used to refine the wavelength calibration. Each of the bandpass filters is inserted into the light to regulate the wavelength and data is taken with the spectrometer. This allows wavelength calibration of the spectrometer. The relative amplitudes transmitted for each wavelength through each fiberoptic cable are observed by repeating the procedure with each type of fiberoptic. For the infrared sensors, only the broadband signal was used to perform the wavelength axis calibration.

The sensor system was tested in an example 75-mm ABS/GOX hybrid rocket motor having a design similar to FIG. 4. The segments of the motor, from the forward end to the aft end, include the injector cap, ignition cap, fuel grain with a phenolic liner, and nozzle. The motor is ignited using a low wattage arc ignition system. The ignition cap is 3D printed from ABS with 100% infill. The forward end of the ignition cap is printed with a hole for the fiberoptic cable and channels for insertion of the ignition electrodes. These are installed with printed ABS inserts and epoxy to protect the wires from combustion. The cap also uses impingement shelves to help concentrate oxygen locally in the head end, facilitating ignition. The fuel grain is machined from a solid rod of extruded ABS, procured commercially. The extruded grain section has essentially the same thermodynamic properties as the printed section but can be procured at considerably less cost. The fuel grain is then encased in a phenolic liner, and the whole assembly is inserted into a commercially procured 6061-T6 aluminum, 75-mm diameter rocket casing.

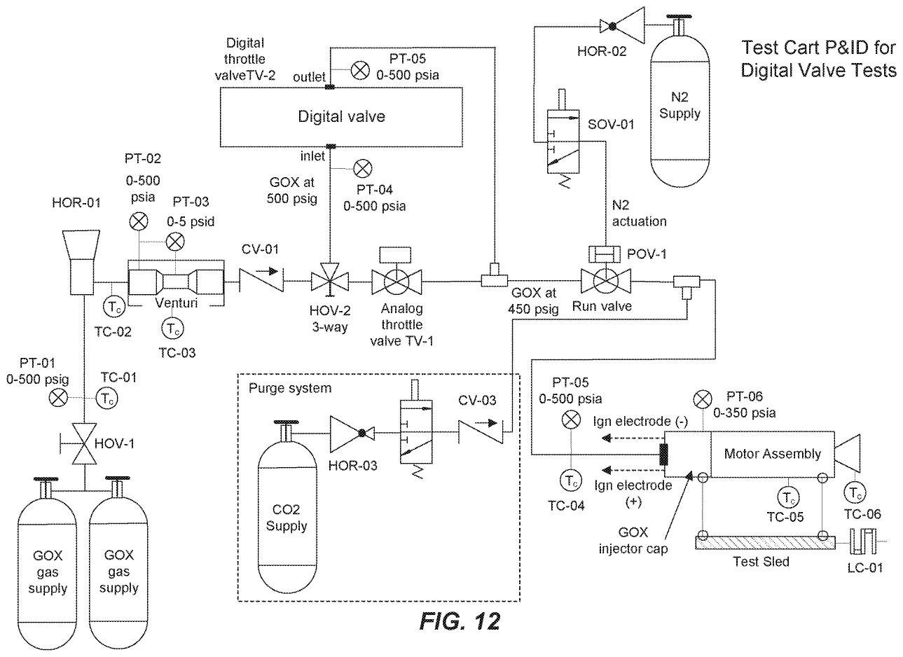

The motor is mounted to a calibrated thrust stand with flexible mounts allowing thrust transmission in the axial direction. FIG. 12 shows the piping and instrumentation diagram (P&ID) of the test stand. Test stand measurements include Venturi and flow-orifice based oxidizer mass flow rate, load cell-based thrust, chamber pressure, GOX tank pressure, injector feed pressure, digital valve inlet and outlet pressures, and multiple thermocouples mounted at various points along the flow path. Also depicted is the High Voltage Power System (HVPS) used for motor ignition. Custom fire control, data acquisition, and processing software are pre-programmed in Lab VIEW to ensure run-to-run test consistency. Connection from the motor instrumentation pallet to the control/data logging laptop is via Universal Serial Bus (USB) cable. Separate laptops were used for motor performance and optical spectrum data logging to reduce the probability of a spectrometer malfunction causing loss of motor control. The test cart is configured to allow both analog (ball valve) and digital throttle control. A hand operated 3-way valve selects between digital and analog control.

The current design allows optical plume sensing at one point along the fuel grain and one point at the end of the nozzle. One location of the fiberoptic cable is to run it through what was previously a secondary GOX port, through the injection cap and ignition cap, through a cut channel along the edge of the fuel grain, and then pointed directly into the center of the motor where combustion occurs. The other fiberoptic location runs from the spectrometer to the aft end of the motor and is held in the nozzle by the end plate.

Sensor data has been collected using the setup described above. The results of the spectrometer/fiberoptic system calibrations, the observations on the durability of the hardware, and the optical results of the hot fire tests, for both temperature prediction and species identification, are described below. The calibration results are presented in this section for each of the systems of interest: The blue Thor Labs cable with the LR-1, the clear Newport cable with the LR-1, and the IR Thor Labs cable with the Qneo.

The procedures are described for deriving the wavelength calibration, transfer function, and signal to noise ratio of each spectrometer/fiberoptic cable combination used for testing. The linear fit from the wavelength calibration is used to adjust the wavelength output from the spectrometers. The transfer functions are used to scale the output magnitudes in order to derive the black body temperature of the plume. The signal to noise ratio estimates are used to process the data using the Wiener filtering algorithm.

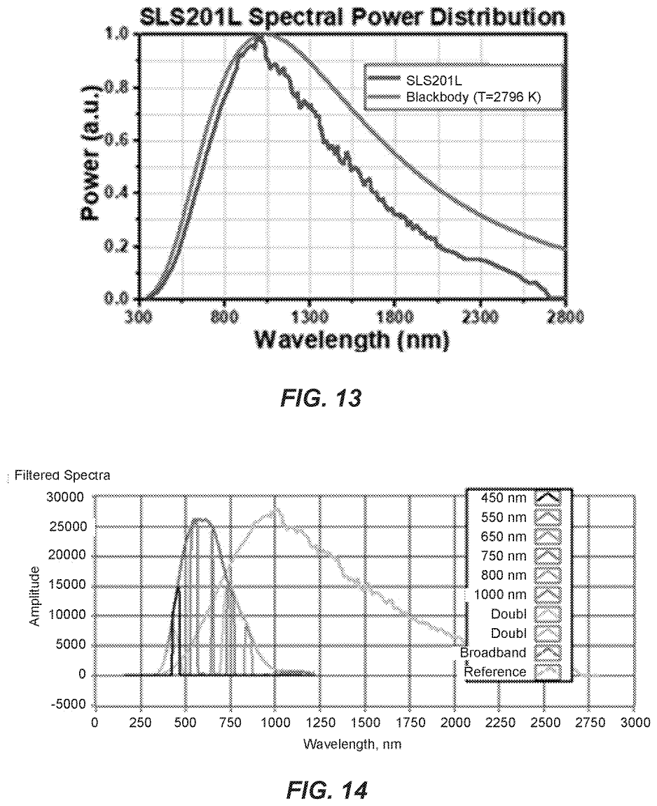

The manufacturer's calibration of the output spectrum for the tungsten light is shown in FIG. 13. The spectrum was measured using NIST traceable standards for reliability. The blackbody spectrum is shown from 300 nm-2800 nm, but the visible light spectrometer has a sensitivity range from 200 nm-1200 nm and the IR spectrometer has a range of 950 nm-1700 nm. Therefore calibration spectra will look distinctly different than the full shape of the calibration curve.

### Blue Thor Labs Cable/LR-1 Calibration

The blue cable burns away the slowest and is primarily used in the nozzle of the rocket motor. FIG. 14 shows the raw calibration data (filtered for noise) compared to the reference blackbody spectra. Each of the smaller peaks is data taken with the bandpass filters for wavelength calibration.

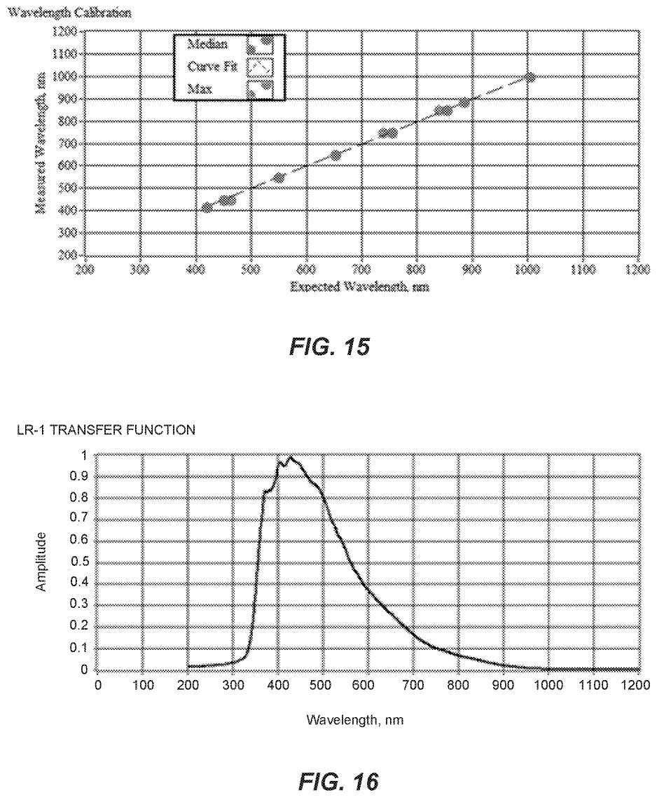

The wavelength calibration is shown in FIG. 15. The measured median wavelength is plotted against the expected median wavelength for each of the bandpass filters. The linear fit from this calibration curve is used to adjust the wavelength axis while the transfer function adjusts the amplitude of the data.

The transfer function for the LR-1 and blue cable is shown in FIG. 16. The purpose of the transfer function is to correct the raw data to look like the actual spectrum from the light source—the raw data is divided by the transfer function to produce the correct spectrum. Since the output of the tungsten light is known, the transfer function is derived by dividing the raw spectrometer reading by the known light output.

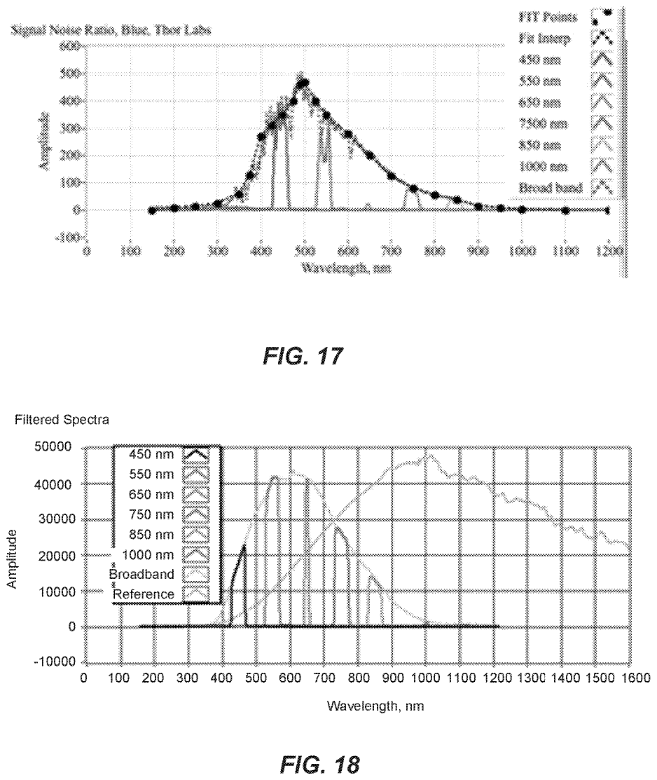

The estimated signal to noise graph for the LR-1 with the blue fiberoptic is shown in FIG. 17.

### Clear Newport Cable/LR-1 Calibration

The clear cable burns away faster than the blue cable and is primarily used in the chamber of the rocket motor for visible light measurements. FIG. 18 shows the raw calibration data (filtered for noise) compared to the reference blackbody spectra. Each of the smaller peaks is data taken with the bandpass filters for wavelength calibration.

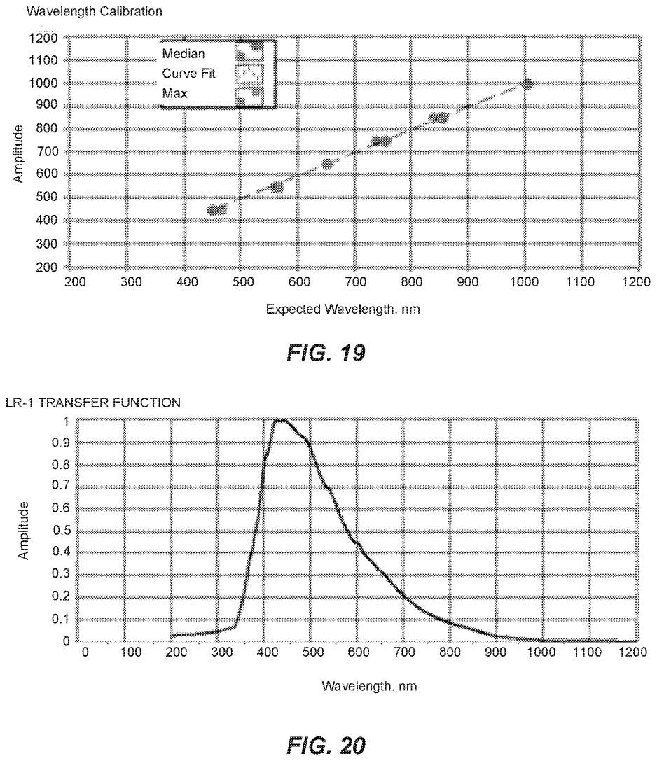

The wavelength calibration is shown in FIG. 19. The measured median wavelength is plotted against the expected median wavelength for each of the bandpass filters. The linear fit from this calibration curve is used to adjust the wavelength axis while the transfer function adjusts the amplitude of the data.

The transfer function for the LR-1 and clear cable is shown in FIG. 20. The purpose of the transfer function is to correct the raw data to look like the actual spectrum from the light source—the raw data is divided by the transfer function to produce the correct spectrum. Since the output of the tungsten light is known, the transfer function is derived by dividing the raw spectrometer reading by the known light output.

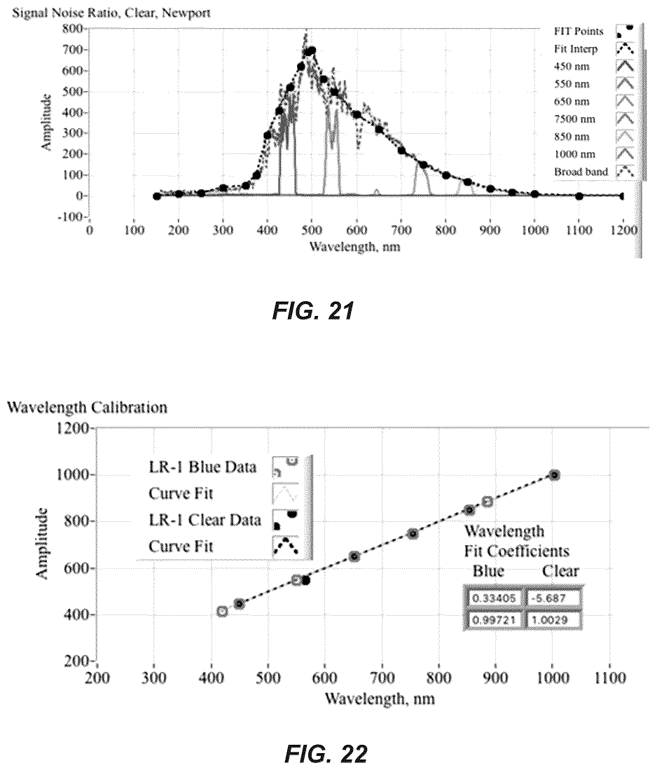

The estimated signal to noise graph for the LR-1 with the clear fiberoptic is shown in FIG. 21. The clear fiberoptic looks to have the highest signal to noise ratio of the three visible light fiberoptic cables.

### Visible Light Cable/LR-1 Comparison

The wavelength calibration curves for the blue and clear cables are compared in FIG. 22. These calibration curves have very similar shapes but different coefficients.

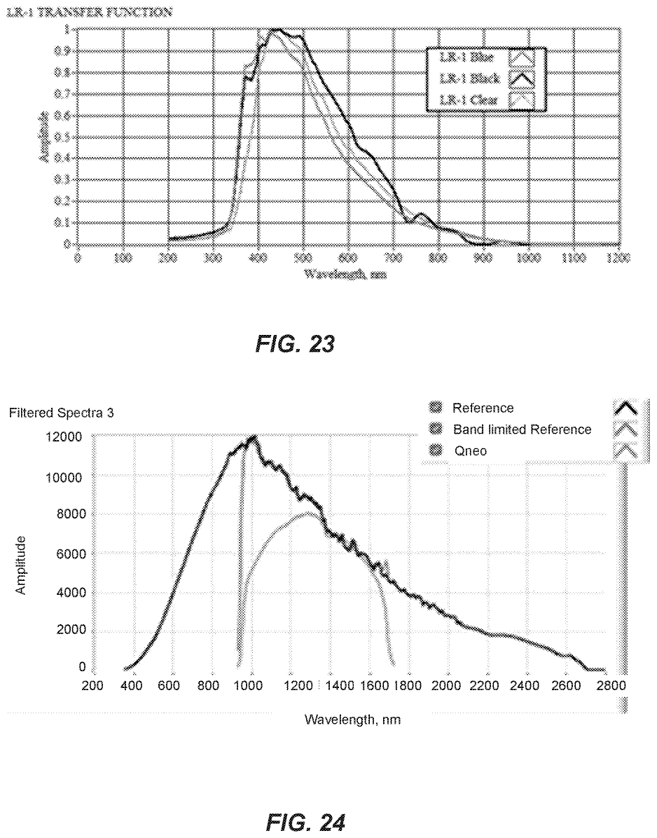

The transfer functions are compared in FIG. 23. The calibrations were done at different exposure times for each cable, so they were each scaled to the same intensity for comparison. The black cable is shown here as well to show why it was rejected. Note that in addition to the dip at 750 nm, the function for the black fiberoptic looks much less smooth and has more waves than the other two.

Clearly, the spectrometer response is the dominant factor with regard to optical calibration; however, the individual cables do have slightly different transfer function shapes and wavelength calibration coefficients.

### IR Thor Labs Cable/Oneo Calibration

The IR fiberoptic cable was the only fiberoptic tested with the Qneo spectrometer as it was the cable found to have the best range for IR light. The results of this calibration are shown below. FIG. 24 shows the filtered spectra compared to the reference data for the light source. The Qneo data already matches the source very well.

The wavelength calibration for the Qneo has less reference points at this time as the lab does not currently have many bandpass filters in the Qneo IR range. However, based on the available calibration data, the instrument appears sufficiently well calibrated to provide reliable data.

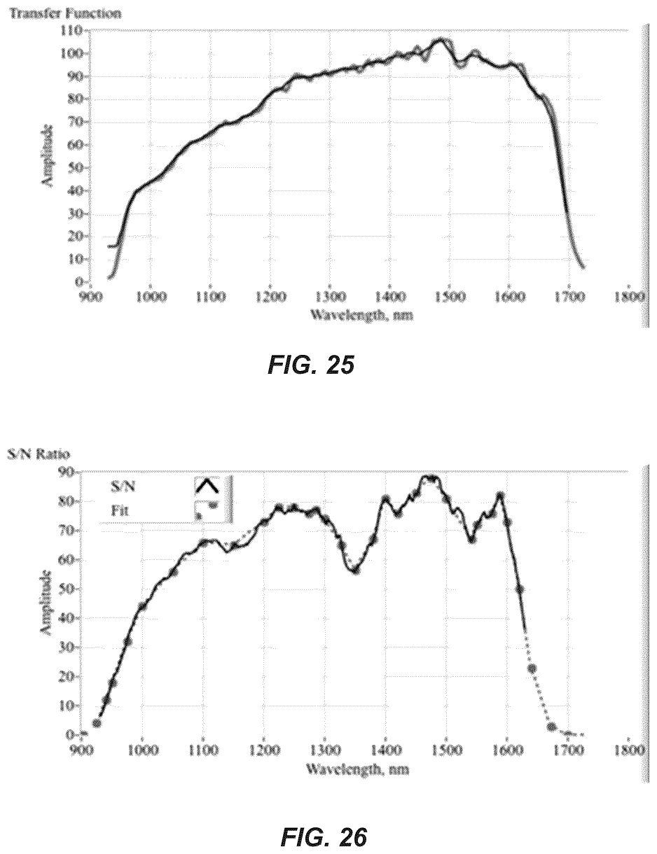

The transfer function for the Qneo with the IR fiberoptic is shown in FIG. 25. It is notably flatter in shape than the visible light spectrometer.

The signal to noise ratio is shown in FIG. 26. Note that it drops off drastically below 1000 nm and above about 1650 nm. This means data outside of 1000 nm-1650 nm is less reliable.

The system was designed with the expectation of the fiberoptic burning away over the course of the burn, while still transmitting light. This is overall the case, but there are some observations about the state of the fiberoptic cables after the burn that are useful to this discussion.

The clear cable is used in the chamber rather than the blue because it burns away better, but the tip of the fiber is still usually observed sticking into the flow after the motor is disassembled. It is also notable that the tip has some soot covering it, which may block some of the light during the end of the test burn. The chamber fiberoptic has overall held up well over testing, indicating that this measurement technique could also be useful in solid fuel rocket motors.

The fiberoptic in the nozzle sees lower temperatures than the fiberoptic in the combustion chamber but there is still a concern that the fiber would simply burn away after the first few seconds of the burn, since it is not encased in the fuel grain as the chamber cable is. While the fiber does recede and may be trimmed and adjusted between each burn, it has successfully transmitted light during each test. The cable does still get charred during the burn and the insulation can start to melt in the hot nozzle assembly. The fiberoptic core itself seems to hold up well even as the sheath has melted away. The fiberoptic cable inserted into the nozzle is adjusted more often than the fiberoptic cable in the chamber but is still a useful measurement as the nozzle is much more accessible for adjustments between burns.

The following section covers the results of the testing campaign. First the fuel regression rate calibration is discussed. Then the results of the flame temperature measurements are presented along with statistical analysis of their accuracy. After that, some preliminary results for chemical species identification are shown.

As described above, the fuel pyrolysis rate is primarily driven by the oxidizer mass flux rate and combined with the changing surface area of the burning fuel, which sets the O/F ratio response for the motor. Due to interdependence between fuel massflow, oxidizer massflow, and instantaneous O/F ratio, the fuel regression rate of hybrid motors varies non-linearly with time and is extremely difficult to measure.

For burns exceeding 15 s, the depleted fuel and oxidizer masses are used to calculate fuel regression rate and oxidizer mass flux over the course of the burn using a mass depletion model. This method is tedious but generally accurate for time averaged calculations. The oxidizer and fuel weights are measured pre- and post-test then divided by burn time to calculate mean massflow rate. The time-averaged longitudinal mean regression rate over the burn duration tburn, is calculated from the consumed fuel mass AMfuel, as in equation 26.

$${\overline{\dot{r}}}_{L} = \frac{Δ {M}_{fuel} / {t}_{burn}}{2 π \cdot {ρ}_{fuel} \cdot [ \frac{{\overline{r}}_{L} ( {t}_{burn} ) + {r}_{0}}{2} ] \cdot L} \qquad ( 26 )$$

In equation 26 r₀ is the initial fuel port radius and r_{L} (t_{bum}) is the mean measured fuel port radius at the end of the burn. The instantaneous fuel port radius is estimated in equation 27.

$${\overline{r}}_{L} ( t ) = {r}_{0} + {\overline{\dot{r}}}_{L} \cdot t \qquad ( 27 )$$

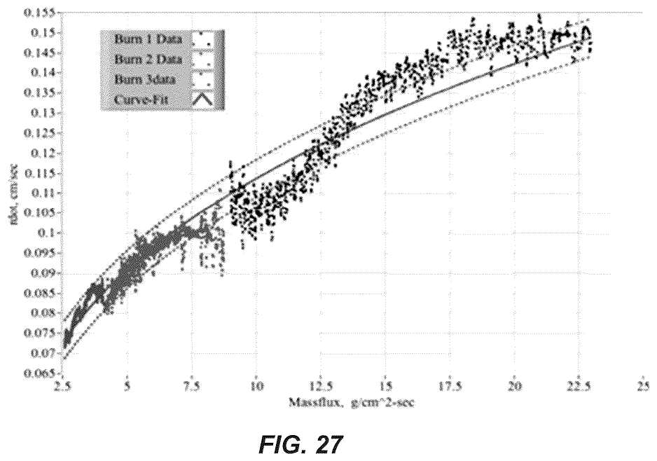

To measure variation in fuel regression rate over time a set of 3 steady state burns were performed on one ABS fuel grain, each at 100% throttle, and pre- and post-burn masses were collected. The fuel regression rates were plotted as a function of fuel port oxidizer mass flux along with power law curve fits and associated error bands. The thrust, total massflow, and fuel massflow varied strongly for the first burn, moderately for the second burn, and are relatively steady for the final burn even though the oxidizer massflow rate remained constant for each. Based on previous discussion, this indicates a fuel rich burn behavior, and therefore a burn exponent n<1/2. FIG. 27 plots the regression rates from all three burns overlapped and calculates a cumulative exponential curve fit.

The steady state burn series was repeated with a new fuel grain at 50% throttle. Table 4 summarizes the curve fit data for both burn series. The curve fit coefficients and associated fit errors for each individual burn, as well as for the concatenated data sets are listed. When averaged over all 6 burns, the resulting curve fit parameters for the mean fuel regression rate are listed in the last column. The estimated burn exponents all lie in the negative O/F shift range.

TABLE 4
Test data: motor fuel regression rate power law curve fit coefficients

| | 50% | | | 100% | | |
|---|---|---|---|---|---|---|
| | a, | | | a, | | |
| Throttle Level Fit Coefficients | $\frac{cm / s}{{( g / {cm}^{2} - s )}^{n}}$ | n | RMS Fit Error, cm/s | $\frac{cm / s}{{( g / {cm}^{2} - s )}^{n}}$ | n | RMS Fit Error, cm/s |
| Burn 1 | 0.00330 | 0.2536 | ±0.0125 | 0.0043 | 0.2836 | ±0.0225 |
| Burn 2 | 0.00405 | 0.3396 | ±0.0135 | 0.00475 | 0.3796 | ±0.0155 |
| Burn 3 | 0.00542 | 0.4265 | ±0.0141 | 0.00625 | 0.4065 | ±0.0161 |
| Concatenated | 0.00414 | 0.3400 | ±0.0112 | 0.00506 | 0.3239 | ±0.0121 |
| Data | | | | | | |
| Mean Values | | | | 0.0046 | 0.3320 | ±0.0117 |

This mean burn exponent of n=0.332 is less than 0.5 and therefore indicates this motor will shift from lean to rich O/F over the course of the burn.

A primary goal of the sensor is to determine the flame temperature during the burn. For most of the data samples, this calculation closely matches the expected temperature predicted by NASA's CEA code. A secondary goal of the sensor is to determine the chemical species present in the combustion plume.

Results from the testing campaign are best shown through examples of good data from certain tests. All of the presented test data were performed with black ABS plastic fuel and GOX oxidizer in the 75 mm motor. The first set of data discussed will go through the analysis procedure in detail using example data. These examples will mostly be from fiberoptic cables in the combustion chamber. Four examples are shown of good data from the chamber, and one example demonstrates data from the nozzle.

This first example is walked through in detail to give a clear picture of the analysis process. The motor performance data is presented first, followed by the optical data. The motor performance data is presented to anchor the mean O/F ratio as it has such a strong influence on the results. The optical frames chosen to display are from the beginning of the burn when there is the least soot on the cable and the clearest signal through the cable. The parameters for the test are shown in tables 5 and 6.

TABLE 5
Rocket Motor Setup

| Date | Burn Num | Motor | Fuel | Oxidizer | Throttle |
|---|---|---|---|---|---|
| Sep. 15, 2023 | burn 1 | 75 mm | black ABS | GOX | V-shape 10 s |

TABLE 6
Spectrometer

| Spectrometer | Cable | Location | Spectrometer Settings |
|---|---|---|---|
| LR-1 | Clear | chamber | exposure: 0.15 ms frame |
| | | | wait: 50 ms |
| | | | Avg: 4 |
| Qneo | IR cable | chamber | exposure: 0.04 ms wait |
| | | | exposure: 2 ms wait scan: 20 |
| | | | ms |
| | | | # frames: 16 |

### Motor Performance Analysis

For this example, the digital throttle system was used to throttle the motor from 100% to 10% and back to 100%. Throttling allows a range of O/F ratios to be observed during a single burn. The motor performance was measured, including (a) commanded throttle, (b) thrust, (c) consumed oxidizer mass, (d) oxidizer, total, and fuel massflow rate, (e) injector and chamber pressure, (f), O/F ratio, (g) combustor (flame) and nozzle exit temperature estimates (from CEA), and (h) the resulting instantaneous specific impulse of the motor over the burn throttling range. The motor thrust increases roughly 18% over time even though the commanded throttle level at the start and end is the same. This is due to the previously described lean to rich O/F shift, which results in a motor that progressively burns cooler with time. The predicted flame and nozzle exit temperatures were calculated using CEA tables, interpolated using the measured chamber pressure and O/F ratios. The combustor temperature was estimated using both the instantaneous and mean O/F ratios. The mean flame temperature and O/F values, calculated across the entire burn time history, will be correlated to the optically sensed flame temperature in the following section.

### Optical Analysis

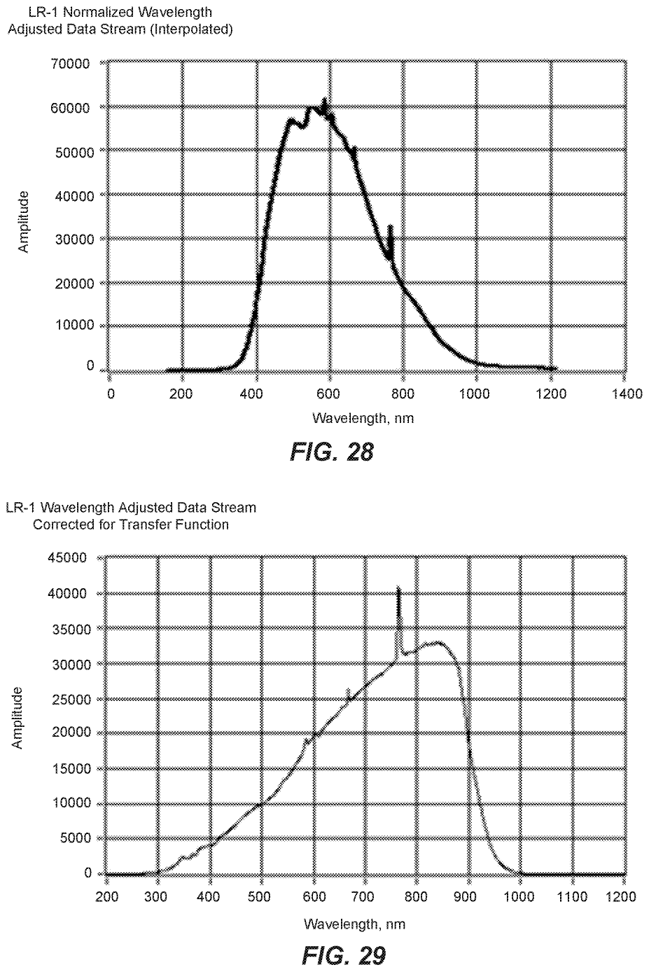

Lab VIEW VI was used for spectral analysis. Raw data from the LR-1 spectrometer are shown in FIG. 28. This is the data as taken by the spectrometer and is what the operator sees during the test. At this point, the general quality of the data is notable with practice, and some chemical spikes are notable, but this is not an accurate representation of the spectra as it still needs to be processed with the transfer function. The result of correcting the data for the transfer function is shown in FIG. 29. Each point of the raw data is divided by the corresponding point on the transfer function, as discussed earlier. In this image, Wiener filtering is also used to reduce the noise level of the data.

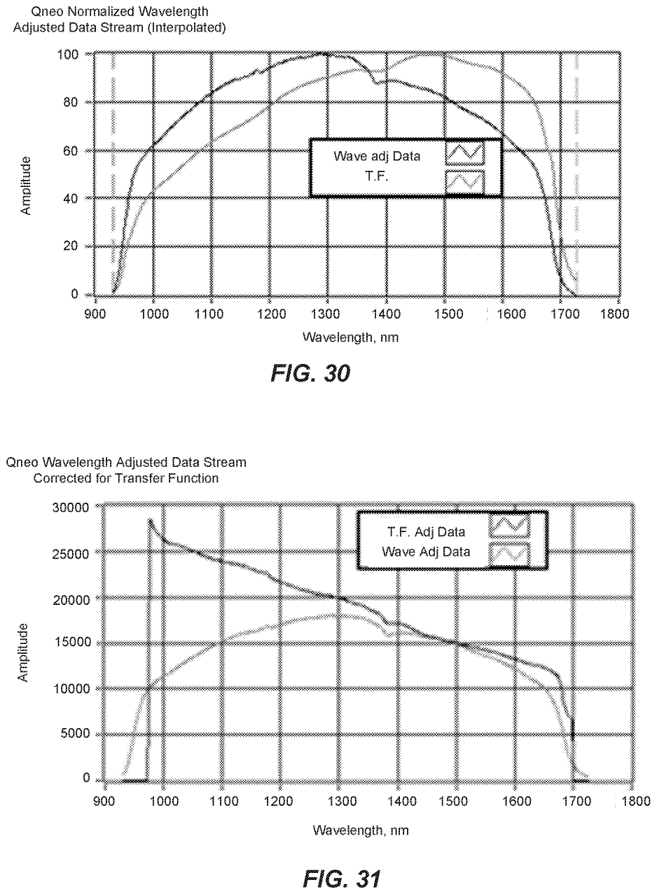

The next step is to look at the raw data from the Qneo IR spectrometer, shown in FIG. 30. Any chemical spikes tend to be less notable in the IR range, but the general shape can be seen. The Qneo data is then corrected for the transfer function and Wiener filtering is used to reduce the noise. The result is shown in FIG. 31.

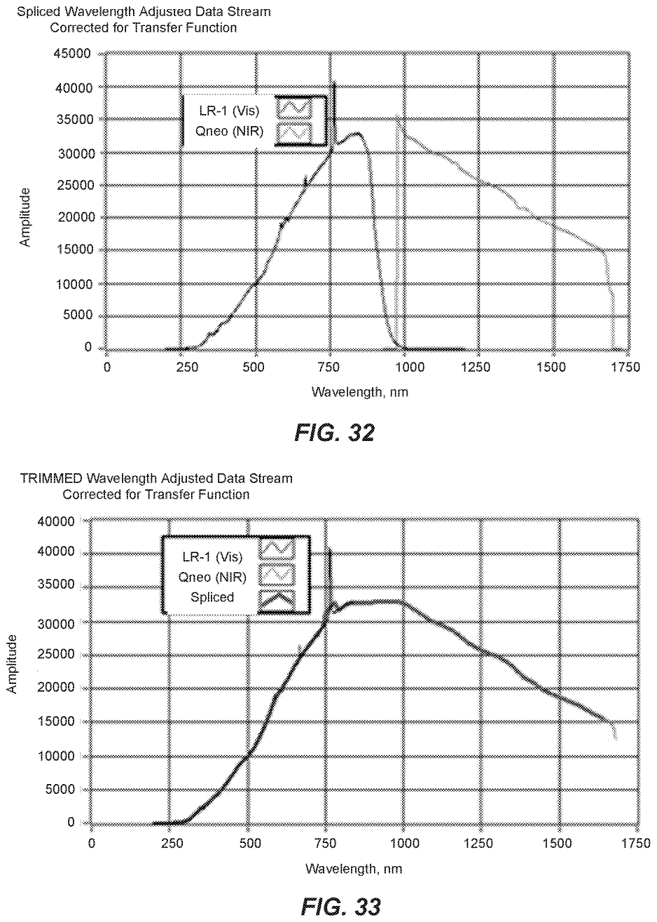

Both sets of data are then graphed on the same plot for comparison. Due to differing exposure times, cable transmission properties, and amounts of soot blocking the cables, the relative amplitudes of the visible light data and the IR light data do not always line up exactly. Therefore, the data can be spliced using the splicing methods described above by finding a best curve fit to Planck's law. Since the Qneo data is usually lower amplitude than the LR-1 data, the Qneo is scaled up until the data appears to have a good curve fit to Planck's law. This is shown in FIG. 32, where the Qneo data is scaled up by a scaling factor of 1.25. FIG. 33 shows both data ranges with a spliced together curve in blue.

Unfortunately, the ranges of the spectrometers where the data is actually reliable leaves a gap between roughly 850 nm and 950 nm. Even more unfortunately, that gap happens to be where the peak of the data usually is for the temperature of the combustion chamber. The curve fit between the two data sets should still give a good estimate of the peak location.

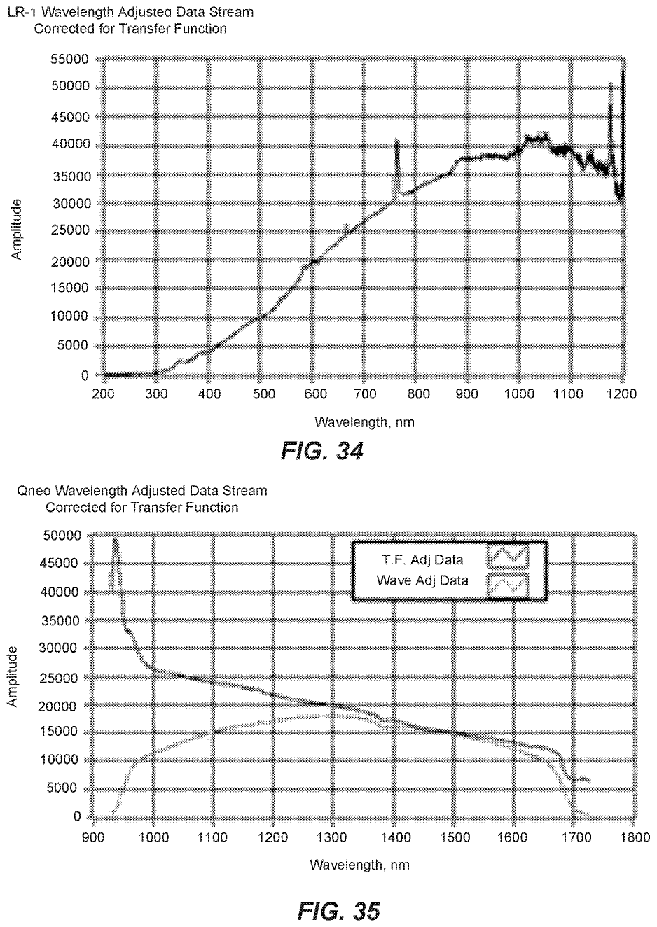

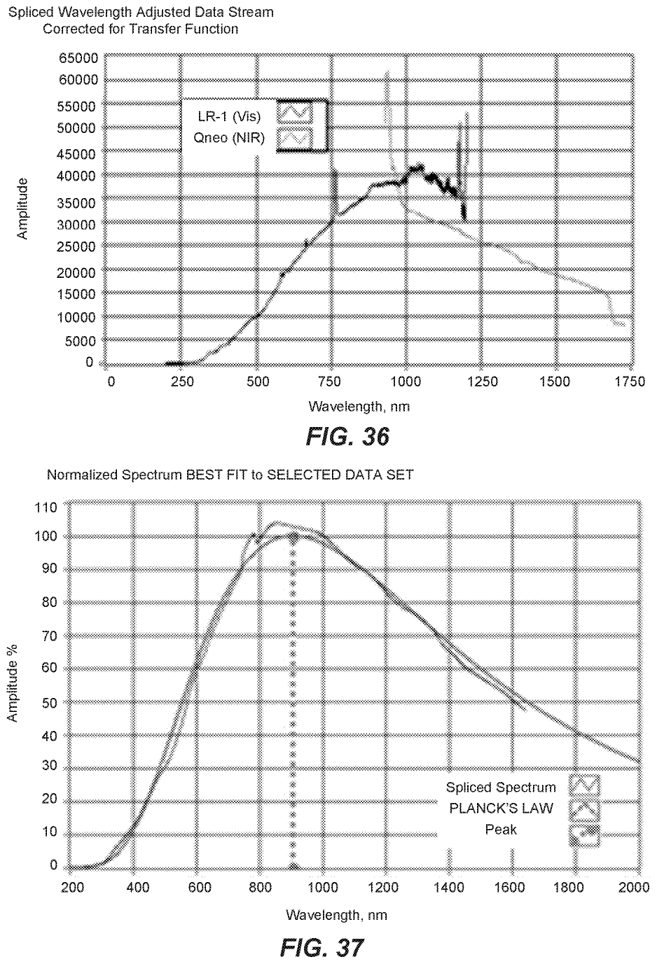

The influence of the Wiener filtering is shown in FIGS. 34-37. FIG. 34 shows the LR-1 data using exact deconvolution (simply dividing the raw data by the transfer function) without any filtering. FIG. 35 shows the Qneo data with the same treatment. FIG. 36 shows both sets overlapping, and FIG. 37 shows the Planck's law curve fit of this spliced data.

As described above, the algorithm is used to define an S/N value below which the data is not valid and ignore any data beyond that point. For this curve fit with exact deconvolution, the resulting temperature is 2908.12° C. from the curve fit or 2906.94° C. from the Wiens law calculation. (The curve fit value is the T value used in calculating the Planck's law curve fit, the other value is from plugging the peak wavelength of the curve into Wien's law.)

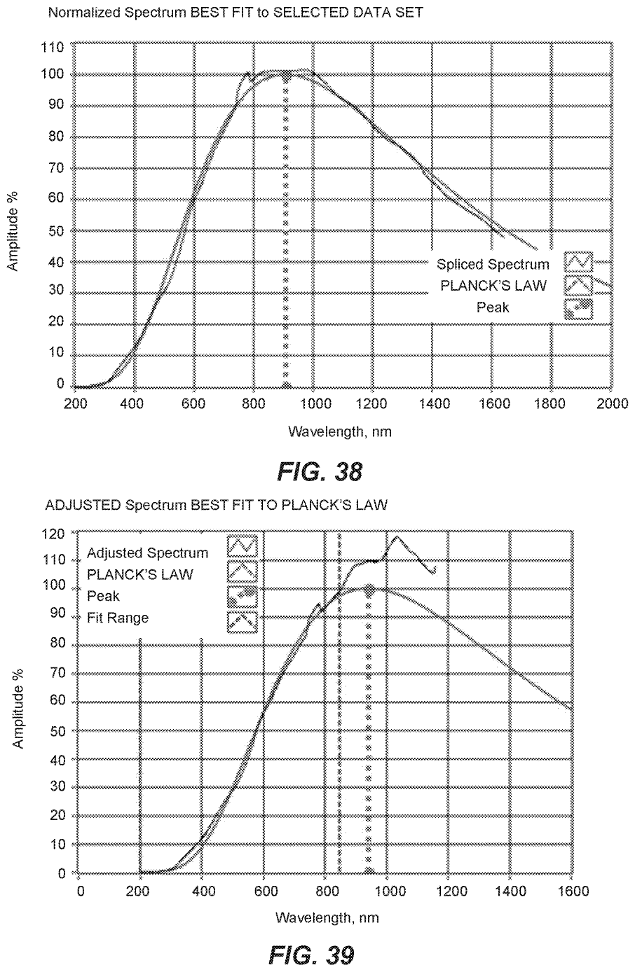

The curve fit looks notably different when the Wiener filter is applied, as shown in FIG. 38. The splicing of the curve lines up better with the nosiest data removed. The spliced curve is also smoothed so the chemical peaks are less notable to make the curve fit clearer.

With the Wiener filtering the curve fit temperature is 2903.44° C. and the Wien's law temperature is 2903.44° C. Not a major difference with the filtering, but likely more accurate.

The initial testing for this method was completed with just the visible light spectrometer. For comparison, the curve fit graph for the same burn with just the visible light data is shown in FIG. 39. This was created using the same frame of data that was spliced with the IR data in FIG. 38.

With just the visible light data, the peak of the curve is outside the range of the useful data. (The visible light spectrometer is only really reliable up to about 850 nm). The temperature from this graph from the curve fit is 2781.38° C. and the Wien's law fit temperature is 2779.74° C. This is a lot lower than the estimated temperature with both data ranges, the IR data yields a much more useful curve fit estimate.

The O/F ratio of this burn is 1.255 and the corresponding CEA predicted temperature is 2899° C. Compared to the measured temperature of 2903° C., this is only 4° C. off.

A second burn was performed with the same grain as example 1. Tables 7 and 8 show the setup details for the test.

TABLE 7
Rocket Motor Setup

| Date | Burn Num | Motor | Fuel | Oxidizer | Throttle |
|---|---|---|---|---|---|
| Sep. 15, 2023 | burn 2 | 75 mm | black | GOX | square wave 10 |
| | | | ABS | | s |

TABLE 8
Spectrometer Setup

| Spectrometer | Cable | Location | Spectrometer Settings |
|---|---|---|---|
| LR-1 | Clear | chamber | exposure: 0.15 ms |
| | | | frame wait: 50 ms Avg: |
| | | | 4 |
| Qneo | IR cable | chamber | exposure: 0.04 ms wait |
| | | | exposure: 2ms wait |
| | | | scan: 20 ms |
| | | | # frames: 16 |

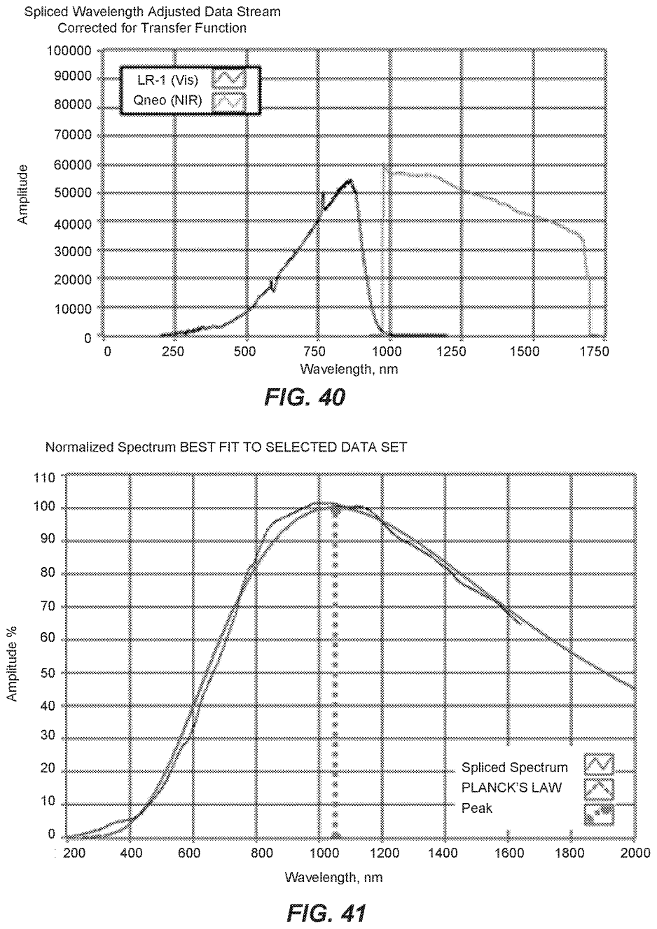

FIG. 40 then shows the two sets of data plotted together. For this set, the Qneo data was scaled up by a factor of 2.3. The corresponding curve fit graph is shown in FIG. 41. The peak on this graph looks well aligned with the projected curve fit.

For this test, the curve fit temperature is 2472.12° C. and the Wien's law temperature is 2486.63° C. The O/F ratio for this burn is 1.011 and the corresponding predicted CEA temperature is 2487° C. This is also a very close guess, within a degree of the Wien's law calculated temperature.

The next example comes from another burn test with similar parameters, described in tables 9 and 10.

TABLE 9
Rocket Motor Setup

| | Burn | | | | |
|---|---|---|---|---|---|
| Date | Num | Motor | Fuel | Oxidizer | Throttle |
| Aug. 09, 2023 | burn 1 | 75 mm | black | GOX | 100%-10%-100% |
| | | | ABS | | for 8 s |

TABLE 10
Spectrometer Setup

| Spectrometer | Cable | Location | Spectrometer Settings |
|---|---|---|---|
| LR-1 | Clear | chamber | exposure: 0.15 ms |
| | | | frame wait: 50 ms |
| | | | Avg: 4 |
| Qneo | IR cable | chamber | exposure: 0.04 ms wait |
| | | | exposure: 2ms wait |
| | | | scan: 20 ms |
| | | | # frames: 10 |

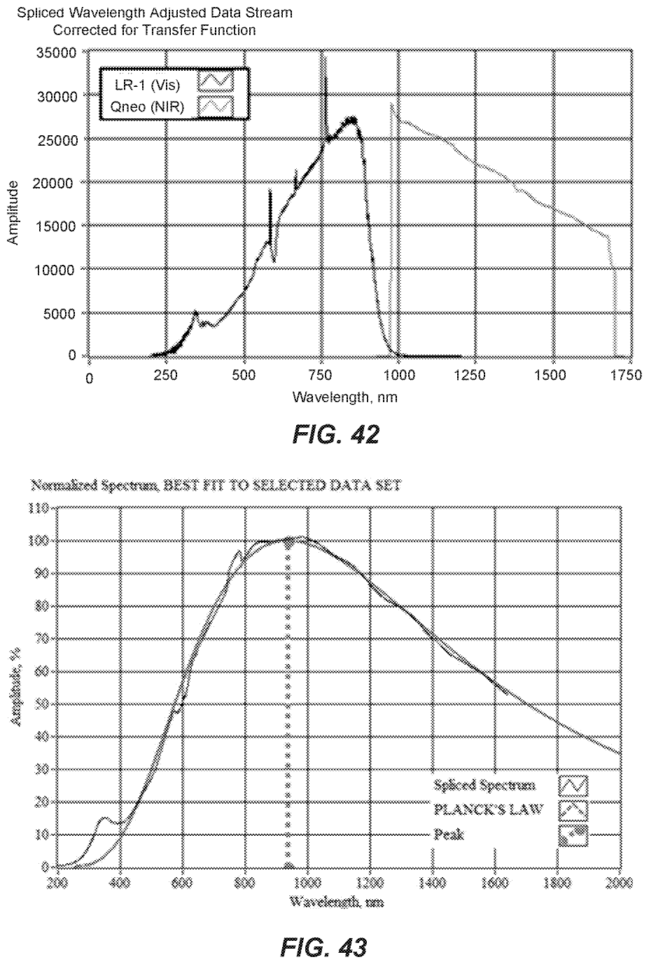

The two sets of data from this test are shown in FIG. 42. The Qneo was actually scaled down this time by a factor of 0.87. The resulting curve fit is shown in FIG. 43. The curve fit temperature is 2802.08° C. and the Wien's law temperature is 2819.46° C. The O/F ratio for the burn is 1.643 and the CEA predicted temperature is 2820° C. Again, the Wien's law prediction is within a degree of the prediction.

This last example of data from the chamber is with the same grain as the previous example. The details are shown in tables 11 and 12.

TABLE 11
Rocket Motor Setup

| | Burn | | | | |
|---|---|---|---|---|---|
| Date | Num | Motor | Fuel | Oxidizer | Throttle |
| Aug. 09, 2023 | burn 2 | 75 mm | black | GOX | Duty cycle 6 |
| | | | ABS | | for 12 s |

TABLE 12
Spectrometer setup

| Spectrometer | Cable | Location | Spectrometer Settings |
|---|---|---|---|
| LR-1 | Clear | chamber | exposure: 0.15 ms |
| | | | frame wait: 50 ms |
| | | | Avg: 4 |
| Qneo | IR cable | chamber | exposure: 0.04 ms wait |
| | | | exposure: 2 ms wait |
| | | | scan: 20 ms |
| | | | # frames: 10 |

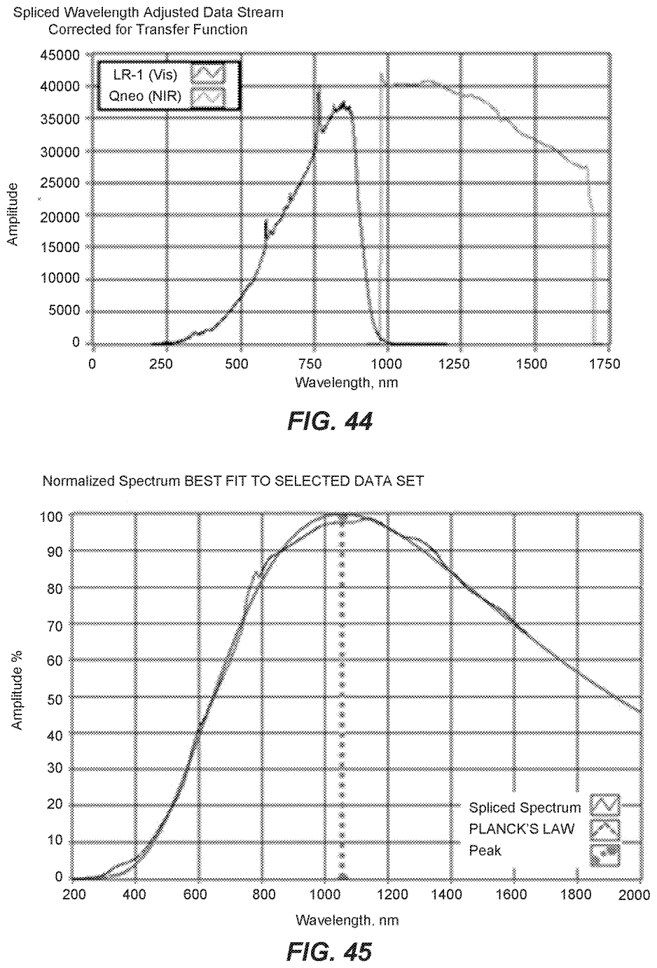

FIG. 44 shows the two sets of data from this test. The Qneo data was scaled up by 1.5. The IR cable may be more affected by soot than the clear cable during the burn, as it seems to need to be scaled up more for later burns with the same grain. This Planck's law curve fit is shown in FIG. 45. The shape fits a little differently than the previous graph but corresponds well to the expected shape of Planck's law.

The curve fit temperature is 2460.18° C. and the Wien's law temperature is 2457.81° C. The O/F ratio is 1.2 and the predicted CEA temperature is 2286° C. This estimate is farther off, only coming within 170° C. of the prediction. As discussed in section 5.3.3, the temperature estimates get farther from the CEA temperatures as the O/F ratio gets higher.

A few burns have been done with both spectrometers taking data in the nozzle, but the Qneo spectrometer did not get strong enough data for a good curve fit with the visual wavelength data. Later tests will likely use a higher exposure time for the Qneo when taking data from the nozzle. For now, an example is shown of visible light only data from an earlier test. The setup is described in tables 13 and 14.

TABLE 13
Rocket Motor Setup

| | Burn | | | | |
|---|---|---|---|---|---|
| Date | Num | Motor | Fuel | Oxidizer | Throttle |
| Jun. 22, 2023 | burn 2 | 75 mm | black | GOX | decreasing |
| | | | ABS | | squares, 12 s |

TABLE 14
Spectrometer Setup

| Spectrometer | Cable | Location | Spectrometer Settings |
|---|---|---|---|
| LR-1 | Blue | Nozzle | exposure: 0.25 ms |
| | | | frame wait: 50 ms Avg: |
| | | | 4 |

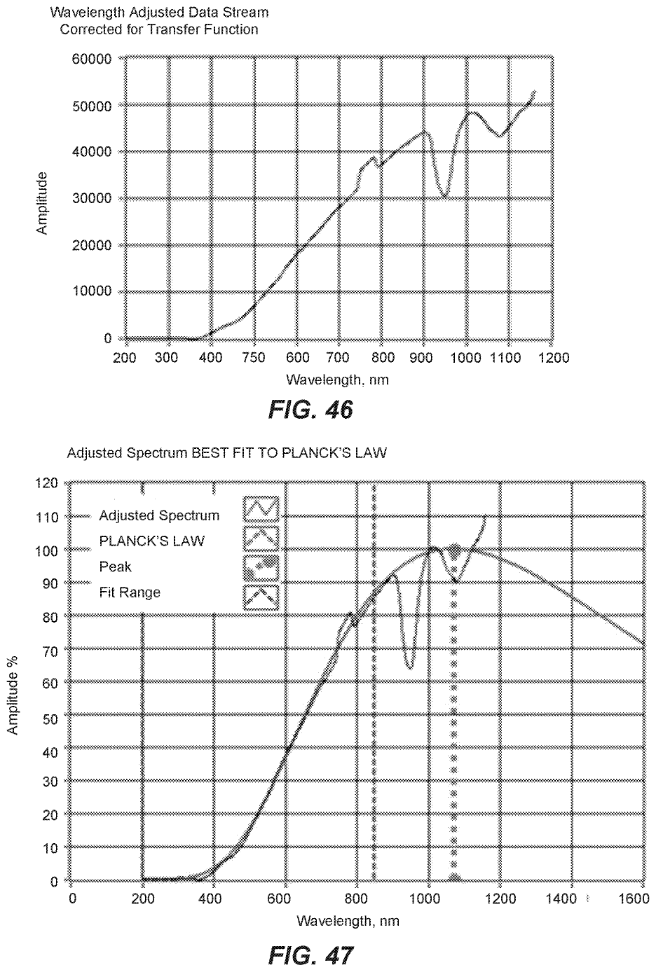

The data from this test is shown in FIG. 46. FIG. 47 then shows the curve fit of this data. The curve fit temperature is _{2415.85}° C. and the Wien's law temperature is 2414.50° C. As expected, the nozzle temperature is lower than the chamber temperature. However, with only visible light data to work from, this data is much less reliable than the previous examples. The O/F ratio should be 0.96 and the corresponding CEA predicted temperature is 2250° C.

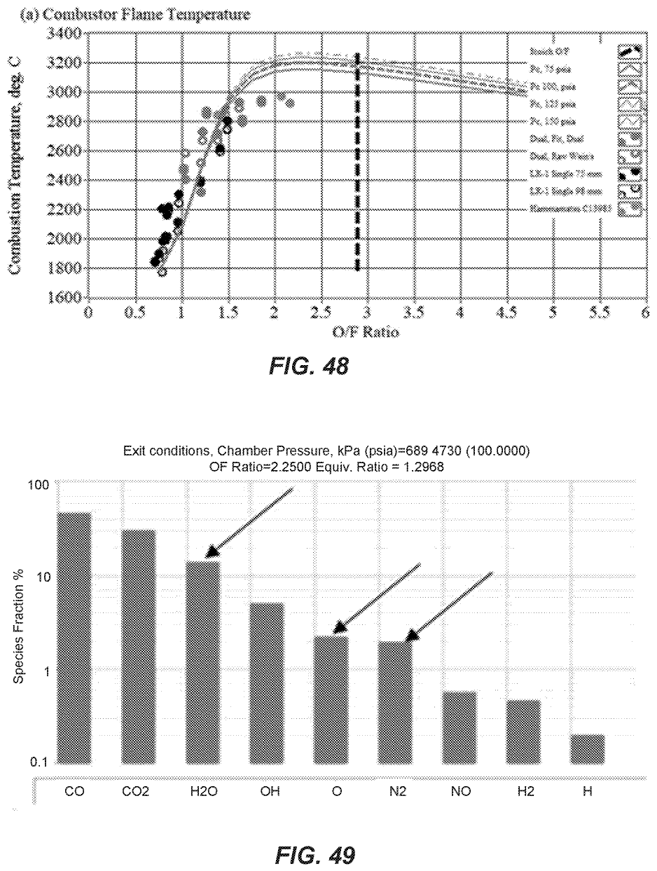

Some statistical analysis can be performed on the collected data. Much more data has been collected in the chamber than the nozzle, and a statistical analysis of the nozzle data would not be very useful, so this section describes chamber data. The set of data described above are from burns with black ABS fuel, GOX oxidizer, and a 75 mm diameter motor. Other burns were performed with beige ABS, hydrogen peroxide oxidizer, a 38 mm motor, and a 98 mm motor. Some of these are shown in FIG. 48 which shows the predicted flame temperature vs O/F ratio curve for ABS/GOX motor. (The 38 mm motor data is not included as those tests used hydrogen peroxide oxidizer and are not a valid comparison).

The O/F ratio value here is an average over the burn, computed by taking the mass of oxidizer burned, measured by keeping the GOX tanks on a scale during the burn, and dividing it by the total mass of fuel burned, measured by taking the difference in mass of the motor before and after the test. Due to the O/F shift over the burn, especially during various throttle patterns, this may not be the exact O/F ratio of the motor at the time the spectral frame was captured. This is a source of error in the CEA temperature estimates and may contribute to the differences between the measured temperature and CEA calculated temperature.

Another source of error is that the CEA calculations were performed based on data from tests with beige ABS, and the enthalpy of the black ABS may be different. There may also be a case of incomplete combustion changing the combustion efficiency of the motor—the calculations assumed 100% efficiency, but the motor may be less efficient at higher O/F ratios. Either of these could explain why the temperature data appears to become less reliable at higher O/F ratios, but currently the cause is unknown.

In addition to the temperature capabilities just presented, some local maxima in the spectrum data have been shown to correspond to emission frequencies of atomic and molecular oxygen, water vapor, and molecular nitrogen; all species known to exist in the hybrid combustion plume. FIG. 49 shows the species predicted by CEA to exist in the plume.

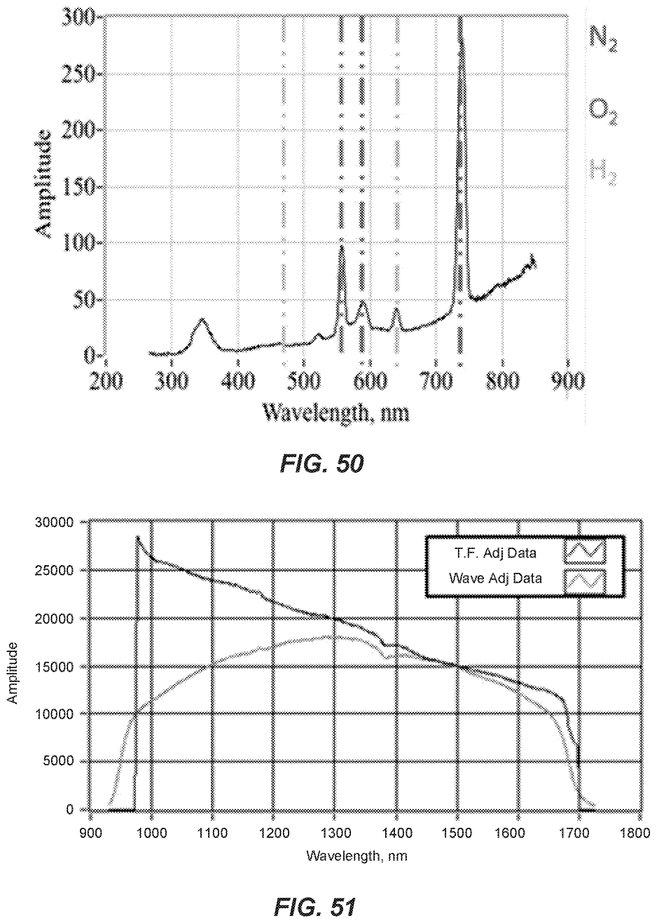

FIG. 50 shows a visible light frame from the nozzle with clear peaks that correspond to the expected peaks for N₂, O₂, and H₂O. The data from the nozzle shows clearer peaks as the black body radiation is less intense than the combustion chamber.

Emission lines have primarily been observed in visible light data. FIG. 51 shows an observed absorption dip due to vapor combustion products like H₂O.

Quantitative analysis has not yet been performed, though this analysis can be done using the Beer-Lambert law, which relates change in light intensity via spectral absorbance or emission to the thermochemical properties of the flow environment. With better intensity calibrations this can allow in-situ quantitative measurements of mole- and mass-fractions in real time across a wide range of O/F ratios and other operating conditions.

### Example 2

In the experiments described above the fiber-optic sensing technique was qualitatively successful in demonstrating feasibility. Unfortunately, for feasibility, as cost- and time-saving measures the tests employed “on-hand” duplex-mode fiber cable, originally designed for Infrared (IR) communications. The duplex-cable passbands were across two distinct wavelengths, 1050 and 1300 nm. These passbands lie beyond of the optical range of the C11708MA spectrometer (640-1040 nm) used for this assessment. Thus, the sensed spectra were highly attenuated, with emission line due to individual species smeared into the background black-body curve. This deficiency was not discovered until after the completion of the initial feasibility assessments. Thus, the success of the early experiment was only partial, and the quantitative accuracy of the original optically-sensed temperature data remain unclear. In order to obtain quantitatively-accurate data, the overall objectives of the follow-on research to be reported here, is to improve the associated system calibration, extend the optical sensing range from the visible spectrum up through mid-infrared wavelengths, and develop more advanced analytical methods.

Because the combustion spectrum of interest encompasses some visible and infrared wavelengths, in this example two spectrometers are used. One spectrometer is designed to measure visible light wavelengths, and the other spectrometer is designed to measure near-infrared wavelengths. This is referred to as a “dual-band” system.

Several more burn tests were performed, similar to the burn tests described above. Three representative tests are described in detail below. Two of these used throttle set constantly to 100% or 50%, and one test involve throttling the motor from 100% to 30% and back to 100% over a 10-second period of time. This deep-throttling allows a range of O/F ratios to be observed during a single burn. For each example, dual band (LR-1 and QNEO) spectrometer data are available, and are correlated to the presented performance data. In order to better understand the effectiveness of the dual-band system, for the first example the dual-band spectra and associated flame temperature solutions are also compared to spectra and flame-temperature solutions as calculated using only the visible-light (LR-1) data. For both the visible-light and IR sensors, each spectrum output was time-tagged and logged for later correlation to the motor performance data. Table 15 summarizes the presented data parameters. Under the Planck's law Column of Table 15, the parameter K is the optimal QNEO Scale factor (from Equation 14), A is the Plank's Curve amplitude, and T is the fit-temperature. Under the Wien's law Column of Table 15, the parameter Amax is the wavelength at which the maximum spliced-curve data amplitude occurs, and T is the corresponding black-body temperature. For example 3, the labeled rows, 3 (a), 3 (b), and 3 (c), correspond to data for the 100%, 30%, and 100% throttle settings.

TABLE 15
Summary of present examples

| | | | Planck's Law Fit | | | Wien's Law Fit | | CEA Flame |
|---|---|---|---|---|---|---|---|---|
| | | | Parameters | | | Parameters | | Temperature |
| Example | Motor | Mean | | | T, K | λₘₐₓ, | T, K | T, K (° C.) |
| No. | (Throttle) | O/F | K | A | (° C.) | nm | (° C.) | η* = 100% |
| 1 | 75-mm, | 1.28 | 17.51 | 259.2 | 3059.8 | 1150 | 3046.0 | 3023.15 |
| | Long | | | | (2786.7) | | (2772.9) | (2750) |
| | (100%) | | | | | | | |
| 2 | Short | 3.40 | 1.363 | 213.4 | 3155.8 | 913 | 3173.9 | 3373.15 |
| | (50%) | | | | (2882.7) | | (2900.8) | (3100) |
| 3(a) | 75-mm, | 1.70 | 1.376 | 223.2 | 3259.7 | 884 | 3278.0 | 3323.15 |
| | Long | | | | (2986.5) | | (3004.9) | (3050) |
| | (100%) | | | | | | | |
| 3(b) | 75-mm, | 0.89 | 90.04 | 4590.8 | 2167.65 | 1314 | 2178.8 | 2223.2 |
| | Long | | | | (1894.5) | | (1905.6) | (1950) |
| | (30%) | | | | | | | |
| 3(c) | 75-mm, | 1.18 | 29.66 | 1020.8 | 2665.7 | 1081 | 2680.6 | 2723.15 |
| | Long | | | | (2392.6) | | (2407.5) | (2450) |
| | (100%) | | | | | | | |

The Planck's law fit parameters and Wien's law fit parameters were calculated similar to the other examples above. In these examples, the spectrum data measured by the two spectrometers was spliced together using Equation 14. The K parameter was found by finding a K value that caused the curve fit to have a minimum variance against Planck's law. For the optimally-spliced data, the temperature is calculated in two ways, 1) the Temperature T from the Planck's law curve fit, and 2) the temperature calculated from Wien's law, applied at the peak-amplitude wavelength of the spliced spectrum. Generally, these two-estimates are found to agree within approximately 10-12° C. As shown by Table 15, in the example 1 the black body temperature from the Planck's law curve fit is calculated to be 3059.8 K (2786.7° C.), and from Wien's law is calculated to be approximately 3046.0 K (2772.9° C.). The curve-fit values agree within 40° C. (1.2%) of the mean CEA-derived temperatures (3023.2 K, 2750° C.). The temperatures estimated in examples 2, 3 (a), 3(b), and 3(c) also align reasonably with the CEA-derived temperatures.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method of measuring temperature of a high-enthalpy exhaust plume, comprising:
placing a sensing end of an optical fiber in an exhaust plume at a flame temperature;
transmitting a combustion spectrum comprising radiation emitted by the exhaust plume through the optical fiber;
receiving the combustion spectrum using a spectrometer connected to a receiving end of the optical fiber opposite from the sensing end;
fitting the combustion spectrum to a black body radiation model; and
calculating the flame temperature using the black body radiation model.

2. The method of claim 1, further comprising outputting the calculated flame temperature to an electronic display.

3. The method of claim 1, wherein calculating the flame temperature comprises finding a peak wavelength of the combustion spectrum and calculating the flame temperature using the peak wavelength.

4. The method of claim 3, wherein the flame temperature is calculated using Wien's displacement law.

5. The method of claim 1, wherein the black body radiation model is Planck's radiation law.

6. The method of claim 1, wherein fitting the combustion spectrum to the black body radiation model comprises correcting the received combustion spectrum by dividing the received combustion spectrum by a transfer function characteristic of the spectrometer and the optical fiber to produce a corrected combustion spectrum, and fitting the corrected combustion spectrum to the black body radiation model.

7. The method of claim 6, wherein fitting the combustion spectrum to the black body radiation model further comprises filtering the corrected combustion spectrum to reduce noise.

8. The method of claim 7, wherein the filtering is done using a Wiener filter.

9. The method of claim 1, wherein the spectrometer is configured to measure at least a portion of wavelengths in a range from 300 nm to 2200 nm.

10. The method of claim 1, wherein the optical fiber is a first optical fiber and wherein the spectrometer is a first spectrometer, wherein the method further comprises placing a sensing end of a second optical fiber in the exhaust plume, transmitting the combustion spectrum of radiation emitted by the exhaust plume through the optical fiber, and receiving the combustion spectrum using a second spectrometer connected to a receiving end of the second optical fiber opposite from the sensing end of the second optical fiber.

11. The method of claim 10, wherein the first spectrometer and the second spectrometer are configured to measure different ranges of wavelengths.

12. The method of claim 11, wherein the first spectrometer is configured to measure in the range of visible to near infrared, and wherein the second spectrometer is configured to measure in a range of near infrared to mid-infrared.

13. The method of claim 11, wherein the first spectrometer is configured to measure at least a portion of wavelengths in the range from 300 nm to 950 nm, and wherein the second spectrometer is configured to measure at least a portion of wavelengths from 950 nm to 2200 nm.

14. The method of claim 11, wherein the first spectrometer and the second spectrometer are configured to measure overlapping ranges of wavelengths.

15. The method of claim 11, wherein the first spectrometer is configured to measure a first wavelength range, wherein the second spectrometer is configured to measure a second wavelength range, and wherein there is a gap between the first wavelength range and the second wavelength range.

16. The method of claim 11, wherein fitting the combustion spectrum to the black body radiation model comprises fitting both the wavelengths measured by the first spectrometer and the wavelengths measured by the second spectrometer.

17. The method of claim 16, wherein the fitting comprises multiplying the wavelengths measured by the first or second spectrometer by a scale factor to account for different output scales of the first and second spectrometers.

18. The method of claim 1, wherein the exhaust plume comprises exhaust from a rocket motor or a gas turbine burner.

19. The method of claim 18, wherein the rocket motor is a solid fuel rocket motor, a liquid fuel rocket motor, or a hybrid rocket motor.

20. The method of claim 18, wherein the rocket motor comprises a solid fuel grain and wherein the optical fiber is inserted through the solid fuel grain into the exhaust plume.

21. The method of claim 20, wherein the optical fiber at least partially melts while the solid fuel grain burns.

22. The method of claim 18, wherein the rocket motor or the gas turbine burner comprises a nozzle and wherein the sensing end of the optical fiber is placed in the nozzle.

23. The method of claim 1, wherein the optical fiber has a core diameter from 300 μm to 1,000 μm.

24. The method of claim 1, wherein the flame temperature is from 1500° C. to 3500° C.

25. The method of claim 1, further comprising detecting peaks in the spectrum corresponding to emission wavelengths of chemical species, and calculating relative amounts of the chemical species in the exhaust plume using the peaks.

26. A fiber optic temperature sensor for high-enthalpy exhaust plumes, comprising:
an optical fiber having a sensing end to be placed in an exhaust plume at a flame temperature, and a receiving end opposite from the sensing end;
a spectrometer connected to the receiving end of the optical fiber to receive a combustion spectrum comprising radiation emitted by the exhaust plume and transmitted through the optical fiber; and
a controller in communication with the spectrometer configured to fit the combustion spectrum to a black body radiation model and calculate the flame temperature using the black body radiation model.

27. The fiber optic temperature sensor of claim 26, wherein the optical fiber is a first optical fiber and wherein the spectrometer is a first spectrometer, wherein the sensor further comprises a second optical fiber having a sensing end placed in the exhaust plume, and a second spectrometer transmitting the combustion spectrum of radiation emitted by the exhaust plume through the optical fiber, and receiving the combustion spectrum using a second spectrometer connected to a receiving end of the second optical fiber opposite from the sensing end of the second optical fiber.

28. A rocket exhaust plume temperature measuring system, comprising:
a rocket motor configured to burn a fuel to form an exhaust plume at a flame temperature;
an optical fiber having a sensing end placed in the exhaust plume and a receiving end opposite from the sensing end;
a spectrometer connected to the receiving end of the optical fiber to receive a combustion spectrum comprising radiation emitted by the exhaust plume and transmitted through the optical fiber; and
a controller in communication with the spectrometer configured to fit the combustion spectrum to a black body radiation model and calculate the flame temperature using the black body radiation model.

29. The system of claim 28, wherein the rocket motor comprises a solid fuel grain and wherein the optical fiber is inserted through the solid fuel grain into the exhaust plume.
